(19) United States
(12) Patent Application Publication
(10) Pub. No.: US 2024/0183926 A1
(43) Pub. Date: Jun. 6, 2024

(54) DYNAMIC SEARCH WINDOW FOR ANGLE OF ARRIVAL ESTIMATION

(71) Applicant: Telefonaktiebolaget LM Ericsson (PUBL), Stockholm (SE)

(72) Inventors: Gustav LINDMARK, Linköping (SE); Per ERNSTRÖM, Stockholm (SE); Florent MUNIER, Västra Frölunda (SE); Satyam DWIVEDI, Solna (SE); Ritesh SHREEVASTAV, Upplands Väsby (SE); Mohammed Yazid LYAZIDI, London (GB)

(21) Appl. No.: 18/553,891

(22) PCT Filed: Apr. 6, 2022
(86) PCT No.: PCT/EP2022/059081

§ 371 Date: Oct. 4, 2023

Related U.S. Application Data
(60) Provisional application No. 63/171,324, filed on Apr. 6, 2021.
(60) Provisional application No. 63/173,870, filed on Apr. 12, 2021.

(51) Int. Cl. G01S 5/00; H04W 64/00

(52) U.S. Cl. CPC G01S 5/0081; H04W 64/00

(57) ABSTRACT

A method (2200) by a first network node (560) includes transmitting (2202), to a second network node (560), a message comprising search window information, The search window information includes information associated with an expected angle and information associated with an uncertainty level of the expected angle. The first network node receives (2204) a response message from the second network node. The response message comprises feedback associated with a use of the search window information by the second network node.

### TECHNICAL FIELD

The present disclosure relates, in general, to wireless communications and, more particularly, systems and methods for providing a dynamic search window for Angle of Arrival estimation.

### BACKGROUND

Positioning has been a topic in Long Term Evolution (LTE) standardization since 3rd Generation Partnership Project (3GPP) Release 9 (Rel. 9). Initially, the primary objective was to fulfill regulatory requirements for emergency call positioning, but other use case like positioning for Industrial-Internet of Things (I-IoT) are becoming important.

FIG. 1A illustrates an architecture supporting positioning in New Radio (NR). Specifically, FIG. 1A illustrates Next Generation-Radio Access Network (NG-RAN) Release 15 (Rel. 15) Location Services (LCS) Protocols. Location Management Function (LMF) is the location node in NR. There are also interactions between the location node and the gNodeB (gNB) via the NR Positioning Protocol A (NRPPa) protocol. The interactions between the gNB and the device is supported via the Radio Resource Control (RRC) protocol, while the location node interfaces with the user equipment (UE) via the LTE positioning protocol (LPP). LPP is common to both NR and LTE.

With regard to FIG. 1A, it is noted that the gNB and next generation-eNodeB (ng-eNB) may not always be present. Additionally, it is noted that when both the gNB and ng-eNB are present, the NG-C interface is only present for one of them.

In the legacy LTE standards, the following techniques are supported:
Enhanced Cell Identifier (cell ID): Essentially cell ID information is used to associate the device to the serving area of a serving cell, and then additional information is used to determine a finer granularity position.
Assisted Global Navigation Satellite System (GNSS): GNSS information is retrieved by the device and supported by assistance information provided to the device from Evolved-Serving Mobile Location Centre (E-SMLC).
Observed Time Difference of Arrival (OTDOA): The device estimates the time difference of reference signals from different base stations and sends to the E-SMLC for multi-lateration.
Uplink Time Difference of Arrival (UTDOA): The device is requested to transmit a specific waveform that is detected by multiple location measurement units (e.g., an eNodeB (eNB)) at known positions. These measurements are forwarded to E-SMLC for multilateration

In NR Release 16 (Rel. 16), a number of positioning features were specified including reference signals, measurements, and positioning methods.

With regard to reference signals, a new downlink (DL) reference signal was specified. The main benefit of the NR DL Positioning Reference Signal (NR DL PRS) as compared to its LTE counterpart, the LTE DL PRS, is the increased bandwidth, which is configurable from 24 to 272 RBs, and which gives a big improvement in Time of Arrival (TOA) accuracy. The NR DL PRS can be configured with a comb factor of 2, 4, 6, or 12. Comb-12 allows for twice as many orthogonal signals as the comb-6 LTE PRS. Beam sweeping is also supported on NR DL PRS in Rel. 16.

Additionally, a new uplink (UL) reference signal, based on the NR UL Sounding Reference Signal (SRS), was introduced and called “SRS for positioning”. The Rel. 16 NR SRS for positioning allows for a longer signal, up to 12 symbols (compared to 4 symbols in Rel. 15 SRS), and a flexible position in the slot (only last six symbols of the slot can be used in Rel. 15 SRS). It also allows for a staggered comb reference element (RE) pattern for improved TOA measurement range and for more orthogonal signals based on comb offsets (comb 2, 4 and 8) and cyclic shifts. The use of cyclic shifts longer than the Orthogonal Frequency Division Multiple (OFDM) symbol divided by the comb factor is, however, not supported by Rel. 16 despite that this is the main advantage of comb-staggering at least in indoor scenarios. Power control based on neighbor cell Synchronization Signal Block (SSB) and DL PRS is supported as well as spatial Quasi Co Location (QCL) relations towards a Channel State Information-Reference Signal (CSI-RS), an SSB, a DL PRS or another SRS.

With regard to positioning techniques, Rel. 16, NR positioning supports the following methods, which were already in LTE, but are enhanced for NR: DL Time Difference of Arrival (DL TDOA), UL TDOA, Enhanced-Cell ID (E-CID), and Radio Access Technology (RAT) independent methods (that are based on non-3GPP sensors such as Global Positioning Satellites (GPS), pressure sensors, Wifi signals, Bluetooth, etc.). Additionally, some new methods for positioning are introduced in NR. One such method includes Multicell Round Trip Time (RTT) during which the LMF collects RTT measurement as the basis for multilateration. Other methods includes DL Angle of Departure (AoD) and UL Angle of Arrival (AoA) in which multilateration is done using angle and power (e.g., Reference Signal Received Power (RSRP) measurements.

With regard to measurement techniques in NR Rel. 16, the following UE measurements are specified:
Downlink Reference Signal Time Difference Measurement (DL RSTD), allowing for e.g. DL TDOA positioning
Multi cell UE Receiver-Transmitter (Rx-Tx) Time Difference measurement, allowing for multi cell RTT measurements
DL PRS RSRP
   Additionally, the following gNB measurements are specified in NR Rel. 16:
Uplink Relative Time of Arrival (UL-RTOA), useful for UL TDOA positioning
gNB Rx-Tx time difference, useful for multi cell RTT measurements
UL Sounding Reference Signal-RSRP (UL SRS-RSRP)
Azimuth-of-Arrival and Zenith-of-Arrival

With regard to signals configurations in NR Rel. 16, the DL PRS is configured by each cell separately. The LMF, which may also be called a location server, collects all configuration via the NRPPa protocol, before sending an assistance data (AD) message to the UE via the LPP protocol. In the UL, the SRS signal is configured in RRC by the serving gNB, which in turns forward appropriate SRS configuration parameters to the LMF upon request.

Certain problems exist, however. For example, in Release 17 (Rel. 17), it was agreed inter alia to specify enhancements for the DL AoD and UL AoA methods. In UL AoA based methods, the UE transmits the SRS toward the gNB, and the gNB measures the AoA of the SRS.

For example, for UL AoA, the following agreement was made during RAN1 #104e:
NR supports at least the following additional assistance signaling from LMF to gNB/Transmission Reception Point (TRP) to facilitate UL measurements of UL-AOA:
   Indication of expected Angle of Arrival (AoA)/Zenith of Arrival (ZoA) value and uncertainty (of the expected AoA/ZoA value) range(s)

Details of procedure for providing the assistance was left for future study. Likewise, reference angle of expected AoA/ZoA was left for future study. It may be noted that, in this formulation, AoA and ZoA are short for azimuth-of-arrival and zenith-of-arrival, respectively. However, herein, the abbreviation AoA will be used for azimuth-of-arrival and UL-AOA for uplink angle of arrival. Where AoA is used it may also be understood to include angle of arrival unless specifically indicated otherwise.

A goal of the agreement is to have the LMF inform the gNB of the angular window since the LMF believes the signal transmitted by the UE will arrive at the gNB/TRP. There are, however, potential issues with a window indicated by the LMF. For example, the LMF could have an erroneous view of the possible AoA and provide an incorrect window. More specifically, the LMF may provide a wrong window center or a wrong window size. Additionally, the UL SRS signal can arrive at the gNB/TRP from several directions corresponding to different paths.

### SUMMARY

Certain aspects of the present disclosure and their embodiments may provide solutions to these or other challenges. For example, according to certain embodiments, methods, procedures, systems, and signaling details are provided for the exchange of information between gNBs and the LMF that allows the LMF to compute and dynamically update an angular search window for each gNB/TRP. The proposed information exchange between the LMF and gNodeBs enables to optimize the angular search window dynamically over time.

According to certain embodiments, a method by a first network node includes transmitting, to a second network node, a message comprising search window information. The search window information includes information associated with an expected angle and information associated with an uncertainty level of the expected angle. The first network node receives a response message from the second network node, wherein the response message comprises feedback associated with a use of the search window information by the second network node.

According to certain embodiments, a first network node is adapted to transmit, to a second network node, a message comprising search window information. The search window information includes information associated with an expected angle and information associated with an uncertainty level of the expected angle. The first network node is adapted to receive a response message from the second network node, wherein the response message comprises feedback associated 15 with a use of the search window information by the second network node.

According to certain embodiments, a method by a second network node includes receiving, from a first network node, a message comprising search window information. The search window information includes information associated with an expected angle, and information associated with an uncertainty level of the expected angle. The second network node transmits a response message to the first network node. The response message comprises feedback associated with a use of the search window information by the second network node.

According to certain embodiments, a second network node is adapted to receive, from a first network node, a message comprising search window information. The search window information includes information associated with an expected angle, and information associated with an uncertainty level of the expected angle. The second network node is adapted to transmit a response message to the first network node. The response message comprises feedback associated with a use of the search window information by the second network node.

Certain embodiments may provide one or more of the following technical advantages. For example, one technical advantage may be that certain embodiments allow the gNodeB to specifically request the LMF to send the AoA search window information. Accordingly, certain embodiments can be used to minimize overhead for NRPPa.

As another example, one technical advantage may be that certain embodiments provide more informative UL-AOA measurements which, in turn, improve the positioning performance. More informative UL-AOA measurements may be enabled by the following, according to certain embodiments:
The UL-AoA search window information IE enables the LMF to control what UL-AoA measurements that the gNB/TRP performs.
The UL-AoA search window information IE enables the gNodeB to perform more granular AoA measurements within limited regions.
The information content of different positioning measurements can vary depending on for instance what other measurements that are available or on prior information about the UE position.

The proposed dynamic and adaptive updates of the UL-AoA search window information IE over time enables the LMF to control the positioning measurements which are collected by the network. This ability can be used by the LMF to make sure that the most informative measurements are being done.

As still another example, a technical advantage may be that certain embodiments introduce a UL-AoA search window response IE to enable more accurate localization by the LMF. As yet another example, a technical advantage may be that certain embodiments provide feedback to the LMF regarding the AoA/ZoA uncertainty window sent in measurement assistance data so that the LMF can update its knowledge and potentially future assistance data.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates NG-RAN Rel. 15 LCS Protocols;

FIG. 2 illustrates an UL-AoA positioning procedure, according to certain embodiments.

FIG. 3 illustrates an information exchange loop for dynamic UL-AoA search window, according to certain embodiments;

FIG. 4 illustrates a sequence (in time) of disjointed UL-AoA Search windows used for multipath UL-AoA measurements, according to certain embodiments;

FIG. 5 example signaling for the periodic computation of UL AoA search window, according to certain embodiments;

FIG. 6 illustrates an example wireless network, according to certain embodiments;

FIG. 7 illustrates an example network node, according to certain embodiments;

FIG. 8 illustrates an example wireless device, according to certain embodiments;

FIG. 9 illustrate an example user equipment, according to certain embodiments;

FIG. 10 illustrates a virtualization environment in which functions implemented by some embodiments may be virtualized, according to certain embodiments;

FIG. 11 illustrates a telecommunication network connected via an intermediate network to a host computer, according to certain embodiments;

FIG. 12 illustrates a generalized block diagram of a host computer communicating via a base station with a user equipment over a partially wireless connection, according to certain embodiments;

FIG. 13 illustrates a method implemented in a communication system, according to one embodiment;

FIG. 14 illustrates another method implemented in a communication system, according to one embodiment;

FIG. 15 illustrates another method implemented in a communication system, according to one embodiment;

FIG. 16 illustrates another method implemented in a communication system, according to one embodiment;

FIG. 17 illustrates an example method by a first network node, according to certain embodiments;

FIG. 18 illustrates an example virtual apparatus, according to certain embodiments;

FIG. 19 illustrates another example method by a first network node, according to certain embodiments;

FIG. 20 illustrates another example virtual apparatus, according to certain embodiments;

FIG. 21 illustrates another example method by a first network node, according to certain embodiments;

FIG. 22 illustrates another example virtual apparatus, according to certain embodiments;

FIG. 23 illustrates another example method by a first network node, according to certain embodiments;

FIG. 24 illustrates another example virtual apparatus, according to certain embodiments;

FIG. 25 illustrates another example method by a first network node, according to certain embodiments;

FIG. 26 illustrates another example method by a first network node, according to certain embodiments; and

FIG. 27 illustrates an example AoA relation.

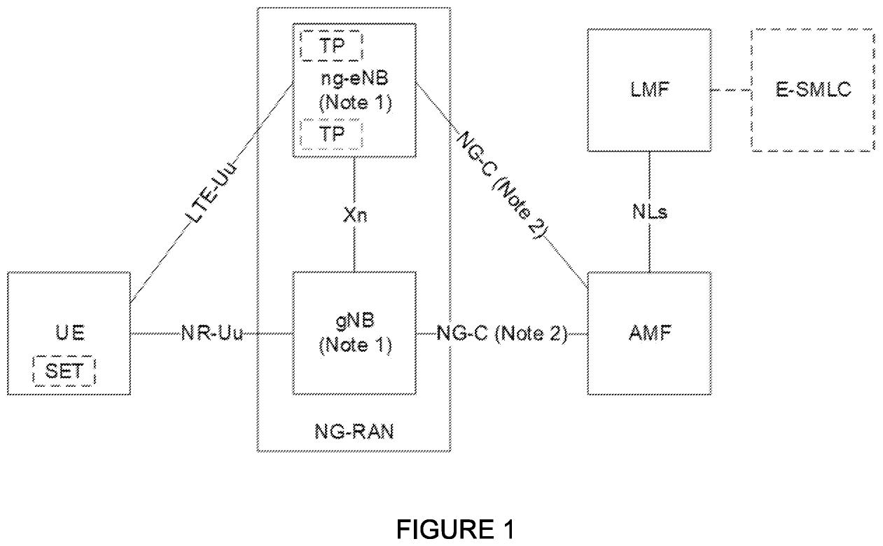

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. MSC, MME, etc.), O&M, OSS, SON, positioning node (e.g. E-SMLC), MDT, test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category M1, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNB, or UE.

According to certain embodiments, methods, procedures, systems, and signaling details are provided for the exchange of information between gNBs and the LMF that allows the LMF to compute and dynamically update an angular search window for each gNB/TRP. The proposed information exchange between the LMF and gNBs enables to optimize the angular search window dynamically over time.

Sending a measurement window is prevalent in timing-based measurements because the true value of the time to be measured lies within useful bounded interval. However, for angle measurements, the true measurement due to the nature of scattering may be random and distributed over the whole range from 0 to 360 degrees. However, according to certain embodiments, methods, procedures, systems, and signaling details are provided that enable the gNB and the LMF to:
Enable feedback and correction to the initial angular window and expected UL-AoA provided to the gNodeB.
From the gNodeB, signal that the gNodeB made use of the window during AoA computation or if the gNodeB used some other window.
From the LMF, signal only partial information. For example, only signal the expected azimuth-of-arrival or zenith-of-arrival and no window when the LMF cannot compute the window with uncertainty.
From the LMF, the angular window can consist of several sub-windows, hence both continuous and discontinuous angle ranges can be realized.

According to a particular embodiment, for example, an IE containing an expected AoA and its uncertainty may be provided as a AoA search window information. In particular embodiments, the AoA search window information may include information related to either or both the AoA and ZoA angles.

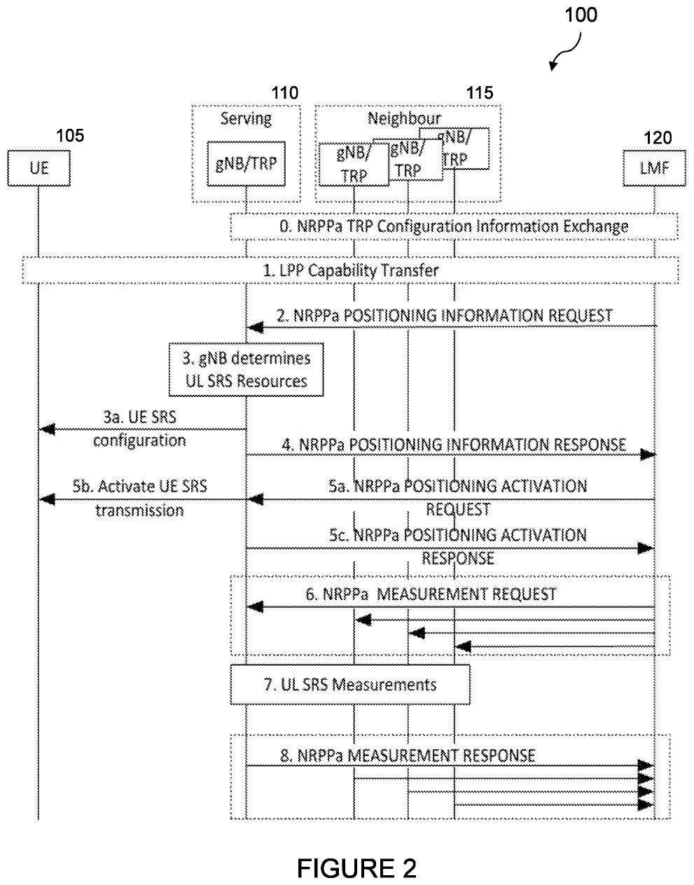

FIG. 2 illustrates an UL-AoA positioning procedure 100, according to certain embodiments. More specifically, FIG. 2 illustrates an example signaling diagram illustrating example interaction between a UE 105, a serving gNB 110, one or more neighbor gNBs 115, and a LMF 120, according to certain embodiments.

As depicted in FIG. 2, the example UL-AoA positioning procedure 100 may include one or more of followings steps inter alia:
Step 0: The initial transfer of information where a first network node (such as, for example a LMF 120) and second network node (such as, for example, a serving gNB 110) can exchange configurations of, for example, the SRS to be measured and other initial parameters.
   In a particular embodiment, the gNB 110 can signal whether it should receive the AoA search window information IE. This depends on whether or not it plans to use the AoA search window in its AoA measurement algorithms. If the gNB 110 does not signal its intent, it is up to the LMF 120 to decide whether to send the AoA search window information IE.
Step 1: The UE 105 and LMF 120 exchange LPP capability information.
Step 2: The LMF 120 sends a NRPPa Positioning Information request to the serving gNB 110.
Steps 3 and 3a: The serving gNB 110 determines, at step 3, UL SRS resources and then sends a UE SRS configuration to the UE 105, at step 3a.
Step 4: The serving gNB 110 sends a NRPPa positioning information response.
Steps 5a, 5b, and 5c: The LMF 120 sends a NRPPa positioning activation request to the serving gNB 110, at step 5a. The serving gNB 110 activates the UE SRS transmission, at step 5b, and sends a NRPPa positioning activation response to the LMF 120, at step 5c.
Step 6: The LMF 120 sends NRPPa MEASUREMENT REQUEST. In this step, the LMF 120 provides the UL-SRS configuration to selected gNBs (e.g., serving gNB 110 and neighboring gNBs 115) and includes all information required to enable the gNBs and Transmission and Reception Points (TRPs) to perform UL measurements. The measurement request message contains information used for UL procedures such as, for example, UL RTOA, UL part of RTT, e-CID measurement, and AoA.
   In a particular embodiment, an Information Element (IE) containing an expected AoA and its uncertainty may be provided as a AoA search window information. This may be an optional information element sent from the LMF 120 to the gNB during Step 6 in the NRPPa MEASUREMENT REQUEST message. If, in a particular embodiment, in Step 0, the gNodeB 110 signaled that it does not want the AoA search window information, then the LMF 120 does not include it in the NRPPa MEASUREMENT REQUEST.
   In another particular embodiment, the signaling of the AoA search window information may take the form of a new, optional information element in the F1 POSITIONING MEASUREMENT REQUEST in the scenario of split gNB architecture.
Step 7: The gNodeBs 110-115 perform the measurements and compute UL AoA.
Step 8: Each gNodeB 110-115 send the NRPPa MEASUREMENT RESPONSE to LMF 120. In release 16, this message consist of:
   PCI, GCI, and TRP ID of the measurement,
   UL Angle of Arrival (azimuth and elevation),
   UL-SRS-RSRP,
   Time stamp of the measurement,
   Quality for each measurement.
      Steps 6-8 may be repeated for any number of measurements.

In a particular embodiment, an optional information element that may be referred herein to as AoA Search window response IE may be included in the NRPPa MEASUREMENT RESPONSE. This IE gives feedback regarding how the AoA search window information was used by the gNB 110. This feedback can be used to along with the actual UL-AoA measurement to refine the UL-AoA search window IE of Step 6 for the next measurement iteration.

In another particular embodiment, the optional information element AoA Search window response may be included in the F1AP POSITIONING MEASUREMENT RESPONSE in the scenario of split gNB architecture.

According to certain embodiments further described herein, the AoA search window Information IE and the AoA search window response IE may be further developed.

Additionally, according to certain embodiments, an iterative procedure is proposed in which the AoA search window information IE signaled in Step 6 can be dynamically adapted over time. For example, the LMF 120 may receive new measurements with information about the position of each UE 105 periodically and/or continuously, in certain embodiments. Thus, what is the optimal search window information can vary over time.

According to certain particular embodiments, the UL-AoA search window information provided by the LMF 120 to each gNB/TRP 110-115 may take any one or more of the following formats:
1. For zenith-of-arrival or for azimuth-of-arrival or for both, a pair {μ, σ} where μ is the expected angle and σ its uncertainty. The variables μ, σ can be integers ranging from 0 to N-1 so that their resolution is 360/N degrees.
2. In one embodiment, the uncertainty azimuth-of-arrival and/or zenith-of-arrival uncertainty σ is an optional field. If the field is absent, the LMF signals it has no prior knowledge of it.
3. For zenith-of-arrival or for azimuth-of-arrival or for both, a pair {k₁, k₂} where k₁ is the lower bound of the window and k₂ is the upper bound of the window. The variables k₁, k₂ can be integers ranging from 0 to N-1 so that their resolution is 360/N degrees.
4. The UL-AoA search window can consist of a list of sub-windows, each one on format 1, 2 or format 3 above.

Format 4 with several sub-windows can be relevant if e.g. the UL-AoA of both the LOS path and additional multi-paths should be measured.

Certain embodiments relate to the UL AoA search window response. For example, in a particular embodiment, a gNB/TRP 110-115 may have some knowledge or information that the LMF 120 does not have access to which motivates the gNB/TRP to override the AoA Search window suggested by the LMF 120 and instead search over a different region. To enable the LMF 120 to optimally localize the UE 105, it is important that the LMF 120 knows the AoA Search window that was actually used by the gNB/TRP 110-115.

According to certain particular embodiments, the AoA search window response provided by the gNB 110-115 to the LMF 120 may take any one or more of the following formats:
A Boolean flag indicating if the AoA Search window provided by LMF 120 was used. This information is useful to the LMF. For example, it can signal to the LMF that the window transmitted from the LMF did not contain any usable received SRS signal.
Any of the formats 1-4 described above for the UL-AoA search window information, but this time the interpretation is that this window was actually used.
The gNB 110-115 can send two types of measurements, one generated using the uncertainty window suggested by the LMF 120 and another without using the uncertainty window. These measurement could be both send together to the LMF 120 which would then have the two possible outcome of the AoA measurement, based on the LMF-suggested window and the gNodeB derived window. The gNB 110-115 could also send multiple measurements, corresponding to different windows.

Additionally, certain embodiments define how the UL AoA search window information IE should be used by the gNB/TRP 110-115. For example, in a particular embodiment, the gNB/TRP 110-115 may only report UL-AoA within the specified search window. This may be considered a strict interpretation of the AoA search window IE.

In another particular embodiment, the gNB/TRP 110-115 may be free to report an UL-AoA outside the search window signaled by the LMF 120. This may be considered a loose interpretation of the AoA search window IE. The loose interpretation can be useful in cases where the gNB/TRP 110-115 has access to information that enables it to make a more intelligible choice of UL-AoA search window than the LMF 120 but still can benefit from receiving a suggested AoA search window from LMF 120.

In another particular embodiment, the gNB 110-115 may inform the LMF 120 whether it is capable a strict and/or loose interpretation of the AoA search window IE. In another embodiment, the gNB 110-115 may inform the LMF 120 whether it has used a strict or loose interpretation of the AoA search window IE.

Certain embodiments relate to the computation of UL-AoA search window information by the LMF 120. For example, according to certain embodiments, the LMF 120 may receive new measurements with information about the position of each UE 105 continuously, substantially continuously, and/or periodically. As such, what is the optimal search window information can vary over time, also depending on intent.

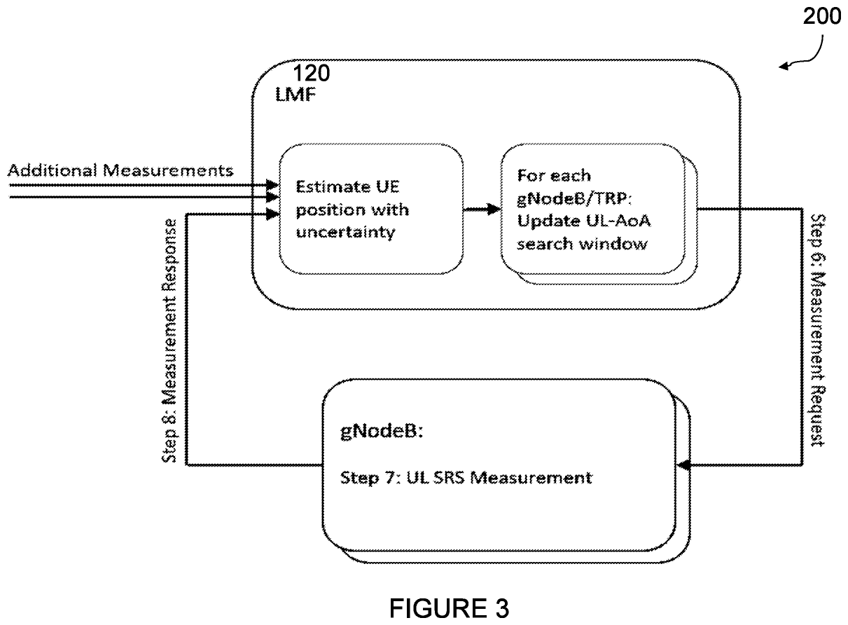

It is noted above that steps 6-8 of FIG. 2 may be repeated for any number of measurements. FIG. 3 illustrates an information exchange loop 200 for dynamic UL-AoA search window, according to certain embodiments. More specifically, FIG. 3 illustrates an information feedback loop where steps 6-8 are repeated so that LMF 120 may collect measurements and requests new measurements. As depicted, LMF 120 operates to estimate UE position with uncertainty. Additionally, for each gNB/TRP 110-115, the LMF 120 receives measurement responses at step 8 and then updates the UL-AoA search window based on these measurement responses prior to sending a new measurement request.

Certain embodiments relate to the maximizing the probability of finding LOS UL AoA within the search window.

For example, in a particular embodiment of Step 6, the proposed UL-AoA search window information IE should be selected so as to maximize the probability that the LOS UL-AoA is within the search window. This should be done for each TRP in the area and at each measurement iteration.

A motivation may be that the LMF continuously tracks the UE position based on a possibly large number of measurements from different information sources. Besides 5G positioning measurements this can include GNSS measurements or barometric sensor readings (for height) of the UE. Besides a point estimate of the UE position, the LMF can estimate the position uncertainty in different directions or a complete probability density function (PDF) for the UE position. The uncertainty of a UE position estimate (or the UE position PDF) depends on many factors, for example, the environment surrounding the UE, the speed of the UE and the quality of past positioning measurements.

Given the location of a TRP, a UE position estimate and uncertainty (or a UE position PDF) can be mapped to an expected UL-AoA with uncertainty for the line-of-sight path toward the TRP. The UL-AoA search window information IE for the TRP should be selected accordingly.

Since in Step 8 the LMF receives additional measurements from the gNodeB, it should update its UE position estimate or position PDF. Consequently, in Step 6 of the next iteration, the UL-AoA search window information IE should be updated accordingly.

Certain embodiments relate to multipath UL AoA. For example, in a particular embodiment, assuming a strict interpretation of the UL-AoA search window, the LMF may send a sequence of Measurement Requests with disjoint UL-AoA search windows. Consequently, any reported UL-AoA in the sequence of measurement responses correspond to different paths. For instance, let the azimuth AoA search windows be 30-60 degrees at time t=1, 60-90 degrees at time t=2, 90-120 degrees at time t=3 etc.

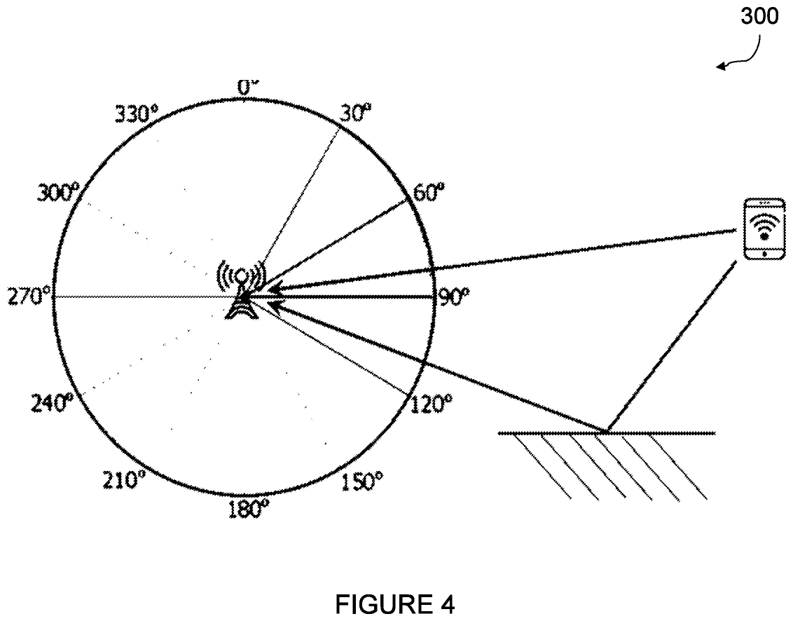

FIG. 4 illustrates a sequence (in time) 300 of disjointed UL-AoA Search windows used for multipath UL-AoA measurements, according to certain embodiments. In this example, the search window is 30-60 degrees at t=1, 60-90 degrees at time t=2 and 90-120 degrees at time t=3. At t=1, no UL-AoA is found, at t=1 UL-AoA=80 degrees is reported, at t=2 UL-AoA=110 degrees is reported. Thus, it is possible to achieve Multipath UL-AoA measurements in this way.

Certain embodiments relate to positioning in only specified areas. For example, in a particular embodiment, the intent of the LMF 120 is not to provide ubiquitous positioning but positioning limited to certain areas. For instance, for legal reasons it can be prohibited to track UEs 105 outside a geographical area, e.g. a factory. In this case the strict interpretation of UL-AoA search window IE (see Section 5.1) can be used to limit the geographical areas where positioning is done.

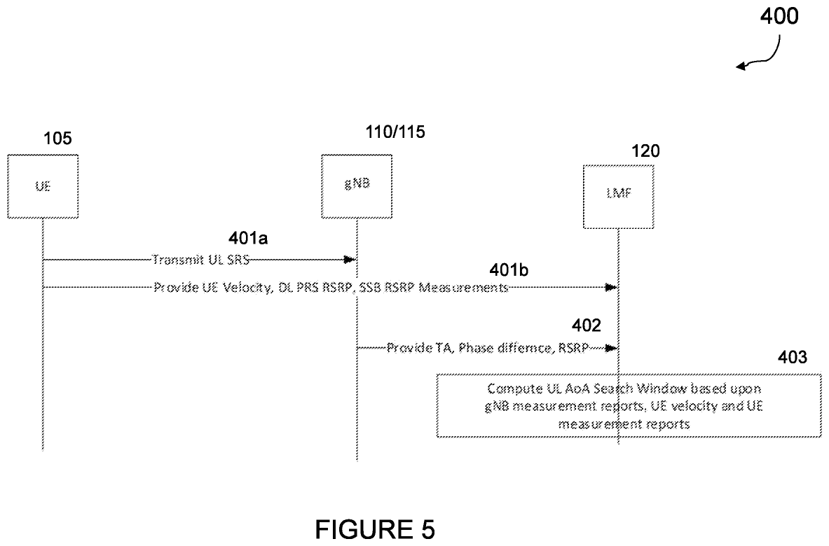

FIG. 5 illustrates example signaling 400 for the periodic computation of UL AoA search window, according to certain embodiments. In the depicted signaling, a UE 105 transmits UL SRS to gNB 110/115 at step 401a. According to certain embodiments, a gNB 110-115 computes the antenna array elements phase difference measurement, TA, and RSRP based upon the transmitted UL SRS from the UE 105 and transmits them to LMF 120, at step 402. Either gNB 110-115 or LMF 120 performs a mapping function/procedure as what should be the expected window AoA based upon current TA, phase difference measurement and RSRP. At step 403, the LMF 120 computes the UL AoA search window based upon gNB measurement reports received at step 402.

In some cases, LMF 120 may optionally take other input into consideration such as UE 105 velocity and UE DL RSRP measurements, Inertial Motion Unit (IMU) sensor information and map the search window for UL AoA, received at step 401b. The LMF computed UL-AoA search window can be provided via NRPPa.

In some embodiments, LMF 120 may also perform co-relation with DL-PRS RSRP (DL-AoD) with current UL AoA or RSRP obtained from SSB/CSI-RS and UL-AoA (gNB RSRP) and try to extrapolate the new UL AoA search window. gNB 110-115 computes drift rate of TA on continuous basis and feeds this to LMF 120. The LMF 120 takes into account how the UE 105 is moving and, thus, adapts the search window accordingly.

In some cases, LMF 120 may also take any IMU sensor information reports to determine the UE trajectory to predict/extrapolate the next search window for UL-AoA.

According to certain embodiments, the LMF 120 may indicate a confidence level in the search window information. As noted above, the LMF may use different information sources for constructing the search window. These sources can be E-CID information, GNSS reports from the UE, previously reported measurements, other UE parameters like velocity of the UE, etc. These different information sources can still result in very similar windows but can have different bearings on final UE position estimation using UL-AoA measurements. The network can also use this information to plan and prioritize UL-AoA measurements. For example, search window built using the GNSS reports can be less reliable than search window built using earlier measurements of the UE 105. Because UL-AOA measurement can be very much scenario dependent, a dense urban scenario can result in very high uncertainty. A window based on timing measurements, for example, can have bounded uncertainty on a level of 10 m, 20 m, etc. However, angular uncertainty, in certain scenarios, can be completely non-informative uniformly probable within [−180, 180].

The confidence level that is determined based on the varying information sources used for building the search window can be indicated by the LMF 120 to the network nodes 110-115 in various ways. Different levels of confidence can be set and indicated by bit combinations or some value or flag can be sent.

Overall, this information allows the network (e.g., network nodes 110-115) to use the search window more wisely.

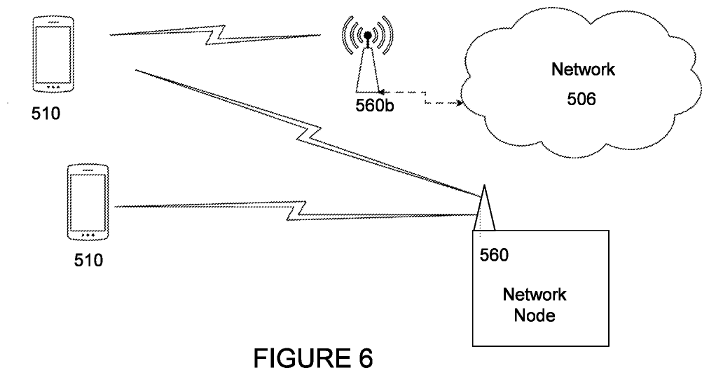

FIG. 6 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network 506, network nodes 560 and 560b, and wireless devices 510. In practice, a wireless network may further include any additional elements suitable to support communication between wireless devices or between a wireless device and another communication device, such as a landline telephone, a service provider, or any other network node or end device. Of the illustrated components, network node 560 and wireless device 510 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 506 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 560 and wireless device 510 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

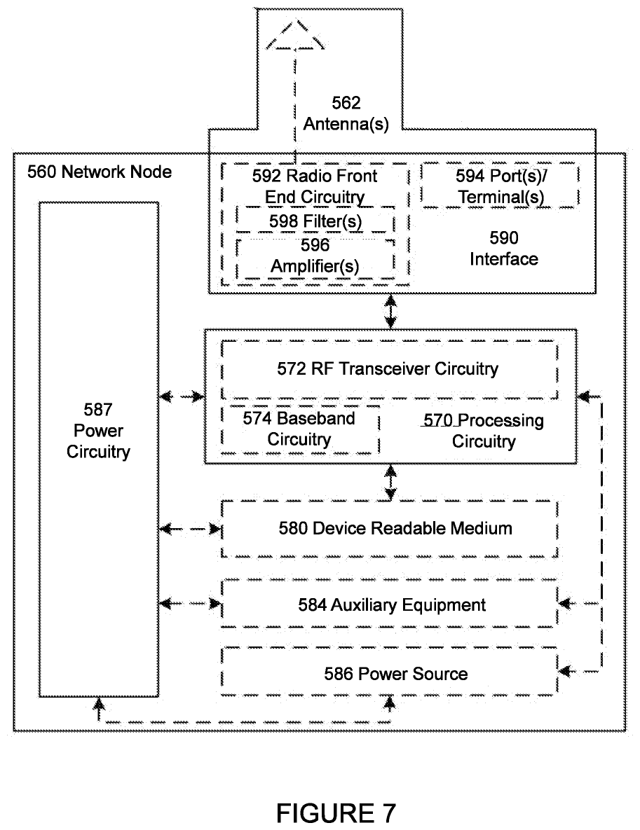

FIG. 7 illustrates an example network node 560, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 7, network node 560 includes processing circuitry 570, device readable medium 580, interface 590, auxiliary equipment 584, power source 586, power circuitry 587, and antenna 562. Although network node 560 illustrated in the example wireless network of FIG. 5 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 560 are depicted as single boxes located within a larger box, or nested within multiple boxes, in practice, a network node may comprise multiple different physical components that make up a single illustrated component (e.g., device readable medium 580 may comprise multiple separate hard drives as well as multiple RAM modules).

Similarly, network node 560 may be composed of multiple physically separate components (e.g., a NodeB component and a RNC component, or a BTS component and a BSC component, etc.), which may each have their own respective components. In certain scenarios in which network node 560 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 560 may be configured to support multiple radio access technologies (RATs). In such embodiments, some components may be duplicated (e.g., separate device readable medium 580 for the different RATs) and some components may be reused (e.g., the same antenna 562 may be shared by the RATs). Network node 560 may also include multiple sets of the various illustrated components for different wireless technologies integrated into network node 560, such as, for example, GSM, WCDMA, LTE, NR, WiFi, or Bluetooth wireless technologies. These wireless technologies may be integrated into the same or different chip or set of chips and other components within network node 560.

Processing circuitry 570 is configured to perform any determining, calculating, or similar operations (e.g., certain obtaining operations) described herein as being provided by a network node. These operations performed by processing circuitry 570 may include processing information obtained by processing circuitry 570 by, for example, converting the obtained information into other information, comparing the obtained information or converted information to information stored in the network node, and/or performing one or more operations based on the obtained information or converted information, and as a result of said processing making a determination.

Processing circuitry 570 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 560 components, such as device readable medium 580, network node 560 functionality. For example, processing circuitry 570 may execute instructions stored in device readable medium 580 or in memory within processing circuitry 570. Such functionality may include providing any of the various wireless features, functions, or benefits discussed herein. In some embodiments, processing circuitry 570 may include a system on a chip (SOC).

In some embodiments, processing circuitry 570 may include one or more of radio frequency (RF) transceiver circuitry 572 and baseband processing circuitry 574. In some embodiments, radio frequency (RF) transceiver circuitry 572 and baseband processing circuitry 574 may be on separate chips (or sets of chips), boards, or units, such as radio units and digital units. In alternative embodiments, part or all of RF transceiver circuitry 572 and baseband processing circuitry 574 may be on the same chip or set of chips, boards, or units.

In certain embodiments, some or all of the functionality described herein as being provided by a network node, base station, eNB or other such network device may be performed by processing circuitry 570 executing instructions stored on device readable medium 580 or memory within processing circuitry 570. In alternative embodiments, some or all of the functionality may be provided by processing circuitry 570 without executing instructions stored on a separate or discrete device readable medium, such as in a hard-wired manner. In any of those embodiments, whether executing instructions stored on a device readable storage medium or not, processing circuitry 570 can be configured to perform the described functionality. The benefits provided by such functionality are not limited to processing circuitry 570 alone or to other components of network node 560 but are enjoyed by network node 560 as a whole, and/or by end users and the wireless network generally.

Device readable medium 580 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 570. Device readable medium 580 may store any suitable instructions, data or information, including a computer program, software, an application including one or more of logic, rules, code, tables, etc. and/or other instructions capable of being executed by processing circuitry 570 and, utilized by network node 560. Device readable medium 580 may be used to store any calculations made by processing circuitry 570 and/or any data received via interface 590. In some embodiments, processing circuitry 570 and device readable medium 580 may be considered to be integrated.

Interface 590 is used in the wired or wireless communication of signalling and/or data between network node 560, network 506, and/or wireless devices 510. As illustrated, interface 590 comprises port(s)/terminal(s) 594 to send and receive data, for example to and from network 506 over a wired connection. Interface 590 also includes radio front end circuitry 592 that may be coupled to, or in certain embodiments a part of, antenna 562. Radio front end circuitry 592 comprises filters 598 and amplifiers 596. Radio front end circuitry 592 may be connected to antenna 562 and processing circuitry 570. Radio front end circuitry may be configured to condition signals communicated between antenna 562 and processing circuitry 570. Radio front end circuitry 592 may receive digital data that is to be sent out to other network nodes or wireless devices via a wireless connection. Radio front end circuitry 592 may convert the digital data into a radio signal having the appropriate channel and bandwidth parameters using a combination of filters 598 and/or amplifiers 596. The radio signal may then be transmitted via antenna 562. Similarly, when receiving data, antenna 562 may collect radio signals which are then converted into digital data by radio front end circuitry 592. The digital data may be passed to processing circuitry 570. In other embodiments, the interface may comprise different components and/or different combinations of components.

In certain alternative embodiments, network node 560 may not include separate radio front end circuitry 592, instead, processing circuitry 570 may comprise radio front end circuitry and may be connected to antenna 562 without separate radio front end circuitry 592. Similarly, in some embodiments, all or some of RF transceiver circuitry 572 may be considered a part of interface 590. In still other embodiments, interface 590 may include one or more ports or terminals 594, radio front end circuitry 592, and RF transceiver circuitry 572, as part of a radio unit (not shown), and interface 590 may communicate with baseband processing circuitry 574, which is part of a digital unit (not shown).

Antenna 562 may include one or more antennas, or antenna arrays, configured to send and/or receive wireless signals. Antenna 562 may be coupled to radio front end circuitry 592 and may be any type of antenna capable of transmitting and receiving data and/or signals wirelessly. In some embodiments, antenna 562 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 562 may be separate from network node 560 and may be connectable to network node 560 through an interface or port.

Antenna 562, interface 590, and/or processing circuitry 570 may be configured to perform any receiving operations and/or certain obtaining operations described herein as being performed by a network node. Any information, data and/or signals may be received from a wireless device, another network node and/or any other network equipment. Similarly, antenna 562, interface 590, and/or processing circuitry 570 may be configured to perform any transmitting operations described herein as being performed by a network node. Any information, data and/or signals may be transmitted to a wireless device, another network node and/or any other network equipment.

Power circuitry 587 may comprise, or be coupled to, power management circuitry and is configured to supply the components of network node 560 with power for performing the functionality described herein. Power circuitry 587 may receive power from power source 586. Power source 586 and/or power circuitry 587 may be configured to provide power to the various components of network node 560 in a form suitable for the respective components (e.g., at a voltage and current level needed for each respective component). Power source 586 may either be included in, or external to, power circuitry 587 and/or network node 560. For example, network node 560 may be connectable to an external power source (e.g., an electricity outlet) via an input circuitry or interface such as an electrical cable, whereby the external power source supplies power to power circuitry 587. As a further example, power source 586 may comprise a source of power in the form of a battery or battery pack which is connected to, or integrated in, power circuitry 587. The battery may provide backup power should the external power source fail. Other types of power sources, such as photovoltaic devices, may also be used.

Alternative embodiments of network node 560 may include additional components beyond those shown in FIG. 7 that may be responsible for providing certain aspects of the network node's functionality, including any of the functionality described herein and/or any functionality necessary to support the subject matter described herein. For example, network node 560 may include user interface equipment to allow input of information into network node 560 and to allow output of information from network node 560. This may allow a user to perform diagnostic, maintenance, repair, and other administrative functions for network node 560.

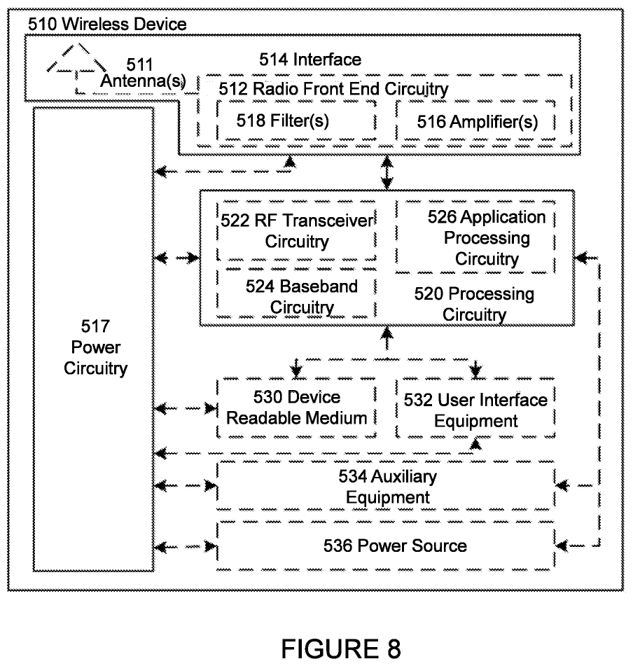

FIG. 8 illustrates an example wireless device 510. According to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IOT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 510 includes antenna 511, interface 514, processing circuitry 520, device readable medium 530, user interface equipment 532, auxiliary equipment 534, power source 536 and power circuitry 537. Wireless device 510 may include multiple sets of one or more of the illustrated components for different wireless technologies supported by wireless device 510, such as, for example, GSM, WCDMA, LTE, NR, WiFi, WiMAX, or Bluetooth wireless technologies, just to mention a few. These wireless technologies may be integrated into the same or different chips or set of chips as other components within wireless device 510.

Antenna 511 may include one or more antennas or antenna arrays, configured to send and/or receive wireless signals, and is connected to interface 514. In certain alternative embodiments, antenna 511 may be separate from wireless device 510 and be connectable to wireless device 510 through an interface or port. Antenna 511, interface 514, and/or processing circuitry 520 may be configured to perform any receiving or transmitting operations described herein as being performed by a wireless device. Any information, data and/or signals may be received from a network node and/or another wireless device. In some embodiments, radio front end circuitry and/or antenna 511 may be considered an interface.

As illustrated, interface 514 comprises radio front end circuitry 512 and antenna 511. Radio front end circuitry 512 comprise one or more filters 518 and amplifiers 516. Radio front end circuitry 512 is connected to antenna 511 and processing circuitry 520 and is configured to condition signals communicated between antenna 511 and processing circuitry 520. Radio front end circuitry 512 may be coupled to or a part of antenna 511. In some embodiments, wireless device 510 may not include separate radio front end circuitry 512; rather, processing circuitry 520 may comprise radio front end circuitry and may be connected to antenna 511. Similarly, in some embodiments, some or all of RF transceiver circuitry 522 may be considered a part of interface 514. Radio front end circuitry 512 may receive digital data that is to be sent out to other network nodes or wireless devices via a wireless connection. Radio front end circuitry 512 may convert the digital data into a radio signal having the appropriate channel and bandwidth parameters using a combination of filters 518 and/or amplifiers 516. The radio signal may then be transmitted via antenna 511. Similarly, when receiving data, antenna 511 may collect radio signals which are then converted into digital data by radio front end circuitry 512. The digital data may be passed to processing circuitry 520. In other embodiments, the interface may comprise different components and/or different combinations of components.

Processing circuitry 520 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 510 components, such as device readable medium 530, wireless device 510 functionality. Such functionality may include providing any of the various wireless features or benefits discussed herein. For example, processing circuitry 520 may execute instructions stored in device readable medium 530 or in memory within processing circuitry 520 to provide the functionality disclosed herein.

As illustrated, processing circuitry 520 includes one or more of RF transceiver circuitry 522, baseband processing circuitry 524, and application processing circuitry 526. In other embodiments, the processing circuitry may comprise different components and/or different combinations of components. In certain embodiments processing circuitry 520 of wireless device 510 may comprise a SOC. In some embodiments, RF transceiver circuitry 522, baseband processing circuitry 524, and application processing circuitry 526 may be on separate chips or sets of chips. In alternative embodiments, part or all of baseband processing circuitry 524 and application processing circuitry 526 may be combined into one chip or set of chips, and RF transceiver circuitry 522 may be on a separate chip or set of chips. In still alternative embodiments, part or all of RF transceiver circuitry 522 and baseband processing circuitry 524 may be on the same chip or set of chips, and application processing circuitry 526 may be on a separate chip or set of chips. In yet other alternative embodiments, part or all of RF transceiver circuitry 522, baseband processing circuitry 524, and application processing circuitry 526 may be combined in the same chip or set of chips. In some embodiments, RF transceiver circuitry 522 may be a part of interface 514. RF transceiver circuitry 522 may condition RF signals for processing circuitry 520.

In certain embodiments, some or all of the functionality described herein as being performed by a wireless device may be provided by processing circuitry 520 executing instructions stored on device readable medium 530, which in certain embodiments may be a computer-readable storage medium. In alternative embodiments, some or all of the functionality may be provided by processing circuitry 520 without executing instructions stored on a separate or discrete device readable storage medium, such as in a hard-wired manner. In any of those particular embodiments, whether executing instructions stored on a device readable storage medium or not, processing circuitry 520 can be configured to perform the described functionality. The benefits provided by such functionality are not limited to processing circuitry 520 alone or to other components of wireless device 510, but are enjoyed by wireless device 510 as a whole, and/or by end users and the wireless network generally.

Processing circuitry 520 may be configured to perform any determining, calculating, or similar operations (e.g., certain obtaining operations) described herein as being performed by a wireless device. These operations, as performed by processing circuitry 520, may include processing information obtained by processing circuitry 520 by, for example, converting the obtained information into other information, comparing the obtained information or converted information to information stored by wireless device 510, and/or performing one or more operations based on the obtained information or converted information, and as a result of said processing making a determination.

Device readable medium 530 may be operable to store a computer program, software, an application including one or more of logic, rules, code, tables, etc. and/or other instructions capable of being executed by processing circuitry 520. Device readable medium 530 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 520. In some embodiments, processing circuitry 520 and device readable medium 530 may be considered to be integrated.

User interface equipment 532 may provide components that allow for a human user to interact with wireless device 510. Such interaction may be of many forms, such as visual, audial, tactile, etc. User interface equipment 532 may be operable to produce output to the user and to allow the user to provide input to wireless device 510. The type of interaction may vary depending on the type of user interface equipment 532 installed in wireless device 510. For example, if wireless device 510 is a smart phone, the interaction may be via a touch screen; if wireless device 510 is a smart meter, the interaction may be through a screen that provides usage (e.g., the number of gallons used) or a speaker that provides an audible alert (e.g., if smoke is detected). User interface equipment 532 may include input interfaces, devices and circuits, and output interfaces, devices and circuits. User interface equipment 532 is configured to allow input of information into wireless device 510 and is connected to processing circuitry 520 to allow processing circuitry 520 to process the input information. User interface equipment 532 may include, for example, a microphone, a proximity or other sensor, keys/buttons, a touch display, one or more cameras, a USB port, or other input circuitry. User interface equipment 532 is also configured to allow output of information from wireless device 510, and to allow processing circuitry 520 to output information from wireless device 510. User interface equipment 532 may include, for example, a speaker, a display, vibrating circuitry, a USB port, a headphone interface, or other output circuitry. Using one or more input and output interfaces, devices, and circuits, of user interface equipment 532, wireless device 510 may communicate with end users and/or the wireless network and allow them to benefit from the functionality described herein.

Auxiliary equipment 534 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 534 may vary depending on the embodiment and/or scenario.

Power source 536 may, in some embodiments, be in the form of a battery or battery pack. Other types of power sources, such as an external power source (e.g., an electricity outlet), photovoltaic devices or power cells, may also be used. wireless device 510 may further comprise power circuitry 537 for delivering power from power source 536 to the various parts of wireless device 510 which need power from power source 536 to carry out any functionality described or indicated herein. Power circuitry 537 may in certain embodiments comprise power management circuitry. Power circuitry 537 may additionally or alternatively be operable to receive power from an external power source; in which case wireless device 510 may be connectable to the external power source (such as an electricity outlet) via input circuitry or an interface such as an electrical power cable. Power circuitry 537 may also in certain embodiments be operable to deliver power from an external power source to power source 536. This may be, for example, for the charging of power source 536. Power circuitry 537 may perform any formatting, converting, or other modification to the power from power source 536 to make the power suitable for the respective components of wireless device 510 to which power is supplied.

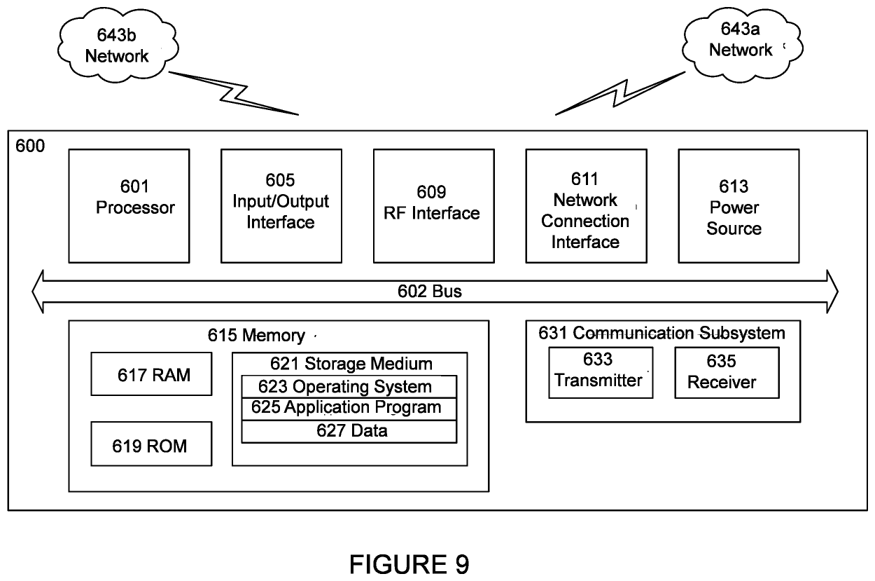

FIG. 9 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 600 may be any UE identified by the 3rd Generation Partnership Project (3GPP), including a NB-IOT UE, a machine type communication (MTC) UE, and/or an enhanced MTC (eMTC) UE. UE 600, as illustrated in FIG. 7, is one example of a wireless device configured for communication in accordance with one or more communication standards promulgated by the 3rd Generation Partnership Project (3GPP), such as 3GPP's GSM, UMTS, LTE, and/or 5G standards. As mentioned previously, the term wireless device and UE may be used interchangeable. Accordingly, although FIG. 9 is a UE, the components discussed herein are equally applicable to a wireless device, and vice-versa.

In FIG. 9, UE 600 includes processing circuitry 601 that is operatively coupled to input/output interface 605, radio frequency (RF) interface 609, network connection interface 611, memory 615 including random access memory (RAM) 617, read-only memory (ROM) 619, and storage medium 621 or the like, communication subsystem 631, power source 633, and/or any other component, or any combination thereof. Storage medium 621 includes operating system 623, application program 625, and data 627. In other embodiments, storage medium 621 may include other similar types of information. Certain UEs may utilize all of the components shown in FIG. 6, or only a subset of the components. The level of integration between the components may vary from one UE to another UE. Further, certain UEs may contain multiple instances of a component, such as multiple processors, memories, transceivers, transmitters, receivers, etc.

In FIG. 9, processing circuitry 601 may be configured to process computer instructions and data. Processing circuitry 601 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 601 may include two central processing units (CPUs). Data may be information in a form suitable for use by a computer.

In the depicted embodiment, input/output interface 605 may be configured to provide a communication interface to an input device, output device, or input and output device. UE 600 may be configured to use an output device via input/output interface 605. An output device may use the same type of interface port as an input device. For example, a USB port may be used to provide input to and output from UE 600. The output device may be a speaker, a sound card, a video card, a display, a monitor, a printer, an actuator, an emitter, a smartcard, another output device, or any combination thereof. UE 600 may be configured to use an input device via input/output interface 605 to allow a user to capture information into UE 600. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 9, RF interface 609 may be configured to provide a communication interface to RF components such as a transmitter, a receiver, and an antenna. Network connection interface 611 may be configured to provide a communication interface to network 643a. Network 643a may encompass wired and/or wireless networks such as a local-area network (LAN), a wide-area network (WAN), a computer network, a wireless network, a telecommunications network, another like network or any combination thereof. For example, network 643a may comprise a Wi-Fi network. Network connection interface 611 may be configured to include a receiver and a transmitter interface used to communicate with one or more other devices over a communication network according to one or more communication protocols, such as Ethernet, TCP/IP, SONET, ATM, or the like. Network connection interface 611 may implement receiver and transmitter functionality appropriate to the communication network links (e.g., optical, electrical, and the like). The transmitter and receiver functions may share circuit components, software or firmware, or alternatively may be implemented separately.

RAM 617 may be configured to interface via bus 602 to processing circuitry 601 to provide storage or caching of data or computer instructions during the execution of software programs such as the operating system, application programs, and device drivers. ROM 619 may be configured to provide computer instructions or data to processing circuitry 601. For example, ROM 619 may be configured to store invariant low-level system code or data for basic system functions such as basic input and output (I/O), startup, or reception of keystrokes from a keyboard that are stored in a non-volatile memory. Storage medium 621 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 621 may be configured to include operating system 623, application program 625 such as a web browser application, a widget or gadget engine or another application, and data file 627. Storage medium 621 may store, for use by UE 600, any of a variety of various operating systems or combinations of operating systems.

Storage medium 621 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 621 may allow UE 600 to access computer-executable instructions, application programs or the like, stored on transitory or non-transitory memory media, to off-load data, or to upload data. An article of manufacture, such as one utilizing a communication system may be tangibly embodied in storage medium 621, which may comprise a device readable medium.

In FIG. 9, processing circuitry 601 may be configured to communicate with network 643b using communication subsystem 631. Network 643a and network 643b may be the same network or networks or different network or networks. Communication subsystem 631 may be configured to include one or more transceivers used to communicate with network 643b. For example, communication subsystem 631 may be configured to include one or more transceivers used to communicate with one or more remote transceivers of another device capable of wireless communication such as another wireless device, UE, or base station of a radio access network (RAN) according to one or more communication protocols, such as IEEE 802.6, CDMA, WCDMA, GSM, LTE, UTRAN, WiMax, or the like. Each transceiver may include transmitter 633 and/or receiver 635 to implement transmitter or receiver functionality, respectively, appropriate to the RAN links (e.g., frequency allocations and the like). Further, transmitter 633 and receiver 635 of each transceiver may share circuit components, software or firmware, or alternatively may be implemented separately.

In the illustrated embodiment, the communication functions of communication subsystem 631 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 631 may include cellular communication, Wi-Fi communication, Bluetooth communication, and GPS communication. Network 643b may encompass wired and/or wireless networks such as a local-area network (LAN), a wide-area network (WAN), a computer network, a wireless network, a telecommunications network, another like network or any combination thereof. For example, network 643b may be a cellular network, a Wi-Fi network, and/or a near-field network. Power source 613 may be configured to provide alternating current (AC) or direct current (DC) power to components of UE 600.

The features, benefits and/or functions described herein may be implemented in one of the components of UE 600 or partitioned across multiple components of UE 600. Further, the features, benefits, and/or functions described herein may be implemented in any combination of hardware, software or firmware. In one example, communication subsystem 631 may be configured to include any of the components described herein. Further, processing circuitry 601 may be configured to communicate with any of such components over bus 602. In another example, any of such components may be represented by program instructions stored in memory that when executed by processing circuitry 601 perform the corresponding functions described herein. In another example, the functionality of any of such components may be partitioned between processing circuitry 601 and communication subsystem 631. In another example, the non-computationally intensive functions of any of such components may be implemented in software or firmware and the computationally intensive functions may be implemented in hardware.

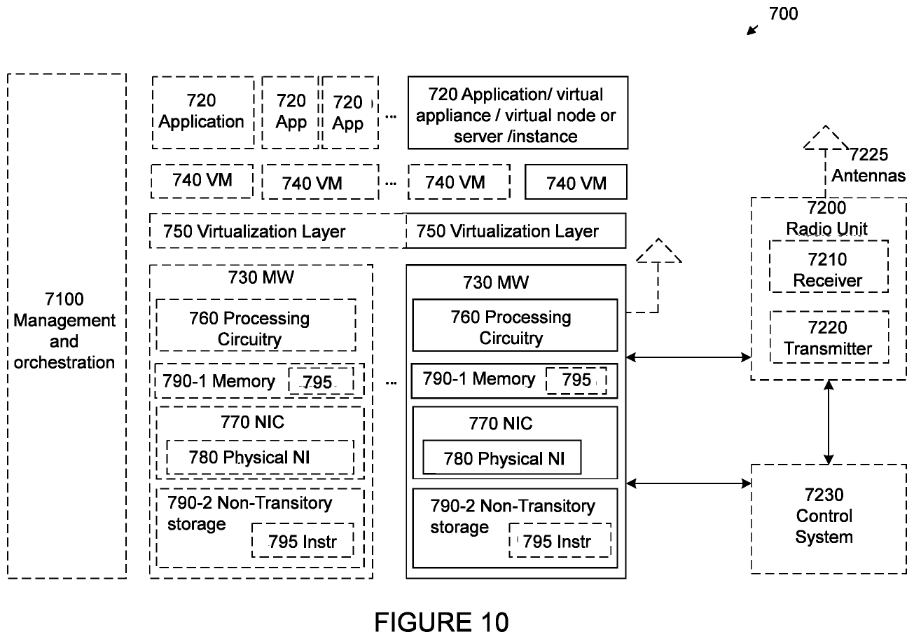

FIG. 10 is a schematic block diagram illustrating a virtualization environment 700 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 700 hosted by one or more of hardware nodes 730. Further, in embodiments in which the virtual node is not a radio access node or does not require radio connectivity (e.g., a core network node), then the network node may be entirely virtualized.

The functions may be implemented by one or more applications 720 (which may alternatively be called software instances, virtual appliances, network functions, virtual nodes, virtual network functions, etc.) operative to implement some of the features, functions, and/or benefits of some of the embodiments disclosed herein. Applications 720 are run in virtualization environment 700 which provides hardware 730 comprising processing circuitry 760 and memory 790. Memory 790 contains instructions 795 executable by processing circuitry 760 whereby application 720 is operative to provide one or more of the features, benefits, and/or functions disclosed herein.

Virtualization environment 700, comprises general-purpose or special-purpose network hardware devices 730 comprising a set of one or more processors or processing circuitry 760, which may be commercial off-the-shelf (COTS) processors, dedicated Application Specific Integrated Circuits (ASICs), or any other type of processing circuitry including digital or analog hardware components or special purpose processors. Each hardware device may comprise memory 790-1 which may be non-persistent memory for temporarily storing instructions 795 or software executed by processing circuitry 760. Each hardware device may comprise one or more network interface controllers (NICs) 770, also known as network interface cards, which include physical network interface 780. Each hardware device may also include non-transitory, persistent, machine-readable storage media 790-2 having stored therein software 795 and/or instructions executable by processing circuitry 760. Software 795 may include any type of software including software for instantiating one or more virtualization layers 750 (also referred to as hypervisors), software to execute virtual machines 740 as well as software allowing it to execute functions, features and/or benefits described in relation with some embodiments described herein.

Virtual machines 740, comprise virtual processing, virtual memory, virtual networking or interface and virtual storage, and may be run by a corresponding virtualization layer 750 or hypervisor. Different embodiments of the instance of virtual appliance 720 may be implemented on one or more of virtual machines 740, and the implementations may be made in different ways.

During operation, processing circuitry 760 executes software 795 to instantiate the hypervisor or virtualization layer 750, which may sometimes be referred to as a virtual machine monitor (VMM). Virtualization layer 750 may present a virtual operating platform that appears like networking hardware to virtual machine 740.

As shown in FIG. 10, hardware 730 may be a standalone network node with generic or specific components. Hardware 730 may comprise antenna 7225 and may implement some functions via virtualization. Alternatively, hardware 730 may be part of a larger cluster of hardware (e.g. such as in a data center or customer premise equipment (CPE)) where many hardware nodes work together and are managed via management and orchestration (MANO) 7100, which, among others, oversees lifecycle management of applications 720.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 740 may be a software implementation of a physical machine that runs programs as if they were executing on a physical, non-virtualized machine. Each of virtual machines 740, and that part of hardware 730 that executes that virtual machine, be it hardware dedicated to that virtual machine and/or hardware shared by that virtual machine with others of the virtual machines 740, forms a separate virtual network elements (VNE).

Still in the context of NFV, Virtual Network Function (VNF) is responsible for handling specific network functions that run in one or more virtual machines 740 on top of hardware networking infrastructure 730 and corresponds to application 720 in FIG. 10.

In some embodiments, one or more radio units 7200 that each include one or more transmitters 7220 and one or more receivers 7210 may be coupled to one or more antennas 7225. Radio units 7200 may communicate directly with hardware nodes 730 via one or more appropriate network interfaces and may be used in combination with the virtual components to provide a virtual node with radio capabilities, such as a radio access node or a base station.

In some embodiments, some signaling can be affected with the use of control system 7230 which may alternatively be used for communication between the hardware nodes 730 and radio units 7200.

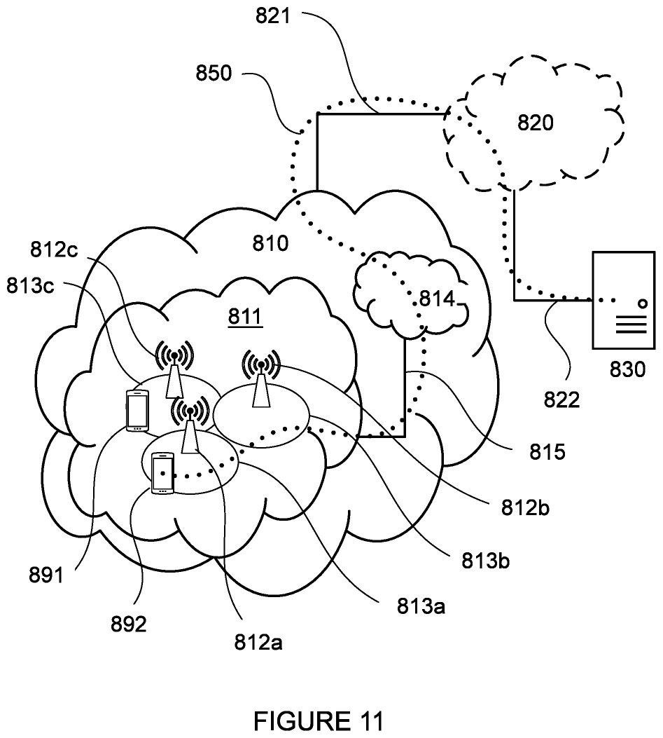

FIG. 11 illustrates a telecommunication network connected via an intermediate network to a host computer in accordance with some embodiments.

With reference to FIG. 11, in accordance with an embodiment, a communication system includes telecommunication network 810, such as a 3GPP-type cellular network, which comprises access network 811, such as a radio access network, and core network 814. Access network 811 comprises a plurality of base stations 812a, 812b, 812c, such as NBs, eNBs, gNBs or other types of wireless access points, each defining a corresponding coverage area 813a, 813b, 813c. Each base station 812a. 812b, 812c is connectable to core network 814 over a wired or wireless connection 815. A first UE 891 located in coverage area 813c is configured to wirelessly connect to, or be paged by, the corresponding base station 812c. A second UE 892 in coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812.

Telecommunication network 810 is itself connected to host computer 830, which may be embodied in the hardware and/or software of a standalone server, a cloud-implemented server, a distributed server or as processing resources in a server farm. Host computer 830 may be under the ownership or control of a service provider or may be operated by the service provider or on behalf of the service provider. Connections 821 and 822 between telecommunication network 810 and host computer 830 may extend directly from core network 814 to host computer 830 or may go via an optional intermediate network 820. Intermediate network 820 may be one of, or a combination of more than one of, a public, private or hosted network; intermediate network 820, if any, may be a backbone network or the Internet; in particular, intermediate network 820 may comprise two or more sub-networks (not shown).

The communication system of FIG. 11 as a whole enables connectivity between the connected UEs 891, 892 and host computer 830. The connectivity may be described as an over-the-top (OTT) connection 850. Host computer 830 and the connected UEs 891, 892 are configured to communicate data and/or signaling via OTT connection 850, using access network 811, core network 814, any intermediate network 820 and possible further infrastructure (not shown) as intermediaries. OTT connection 850 may be transparent in the sense that the participating communication devices through which OTT connection 850 passes are unaware of routing of uplink and downlink communications. For example, base station 812 may not or need not be informed about the past routing of an incoming downlink communication with data originating from host computer 830 to be forwarded (e.g., handed over) to a connected UE 891. Similarly, base station 812 need not be aware of the future routing of an outgoing uplink communication originating from the UE 891 towards the host computer 830.

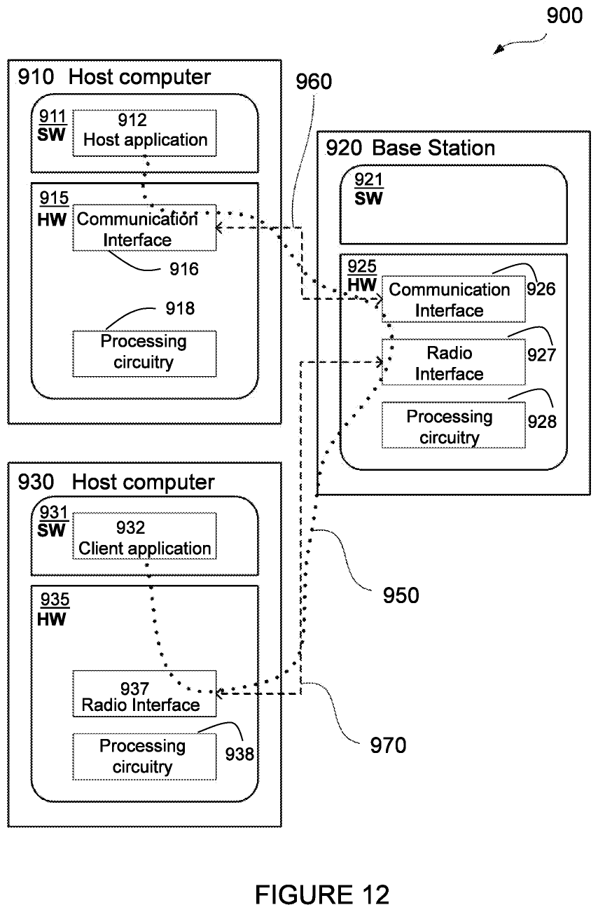

FIG. 12 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 12. In communication system 900, host computer 910 comprises hardware 915 including communication interface 916 configured to set up and maintain a wired or wireless connection with an interface of a different communication device of communication system 900. Host computer 910 further comprises processing circuitry 918, which may have storage and/or processing capabilities. In particular, processing circuitry 918 may comprise one or more programmable processors, application-specific integrated circuits, field programmable gate arrays or combinations of these (not shown) adapted to execute instructions. Host computer 910 further comprises software 911, which is stored in or accessible by host computer 910 and executable by processing circuitry 918. Software 911 includes host application 912. Host application 912 may be operable to provide a service to a remote user, such as UE 930 connecting via OTT connection 950 terminating at UE 930 and host computer 910. In providing the service to the remote user, host application 912 may provide user data which is transmitted using OTT connection 950.

Communication system 900 further includes base station 920 provided in a telecommunication system and comprising hardware 925 enabling it to communicate with host computer 910 and with UE 930. Hardware 925 may include communication interface 926 for setting up and maintaining a wired or wireless connection with an interface of a different communication device of communication system 900, as well as radio interface 927 for setting up and maintaining at least wireless connection 970 with UE 930 located in a coverage area (not shown in FIG. 12) served by base station 920. Communication interface 926 may be configured to facilitate connection 960 to host computer 910. Connection 960 may be direct or it may pass through a core network (not shown in FIG. 12) of the telecommunication system and/or through one or more intermediate networks outside the telecommunication system. In the embodiment shown, hardware 925 of base station 920 further includes processing circuitry 928, which may comprise one or more programmable processors, application-specific integrated circuits, field programmable gate arrays or combinations of these (not shown) adapted to execute instructions. Base station 920 further has software 921 stored internally or accessible via an external connection.

Communication system 900 further includes UE 930 already referred to. Its hardware 935 may include radio interface 937 configured to set up and maintain wireless connection 970 with a base station serving a coverage area in which UE 930 is currently located. Hardware 935 of UE 930 further includes processing circuitry 938, which may comprise one or more programmable processors, application-specific integrated circuits, field programmable gate arrays or combinations of these (not shown) adapted to execute instructions. UE 930 further comprises software 931, which is stored in or accessible by UE 930 and executable by processing circuitry 938. Software 931 includes client application 932. Client application 932 may be operable to provide a service to a human or non-human user via UE 930, with the support of host computer 910. In host computer 910, an executing host application 912 may communicate with the executing client application 932 via OTT connection 950 terminating at UE 930 and host computer 910. In providing the service to the user, client application 932 may receive request data from host application 912 and provide user data in response to the request data. OTT connection 950 may transfer both the request data and the user data. Client application 932 may interact with the user to generate the user data that it provides.

It is noted that host computer 910, base station 920 and UE 930 illustrated in FIG. 12 may be similar or identical to host computer 830, one of base stations 812a, 812b, 812c and one of UEs 891, 892 of FIG. 11, respectively. This is to say, the inner workings of these entities may be as shown in FIG. 12 and independently, the surrounding network topology may be that of FIG. 11.

In FIG. 12. OTT connection 950 has been drawn abstractly to illustrate the communication between host computer 910 and UE 930 via base station 920, without explicit reference to any intermediary devices and the precise routing of messages via these devices. Network infrastructure may determine the routing, which it may be configured to hide from UE 930 or from the service provider operating host computer 910, or both. While OTT connection 950 is active, the network infrastructure may further take decisions by which it dynamically changes the routing (e.g., on the basis of load balancing consideration or reconfiguration of the network).

Wireless connection 970 between UE 930 and base station 920 is in accordance with the teachings of the embodiments described throughout this disclosure. One or more of the various embodiments improve the performance of OTT services provided to UE 930 using OTT connection 950, in which wireless connection 970 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 950 between host computer 910 and UE 930, in response to variations in the measurement results. The measurement procedure and/or the network functionality for reconfiguring OTT connection 950 may be implemented in software 911 and hardware 915 of host computer 910 or in software 931 and hardware 935 of UE 930, or both. In embodiments, sensors (not shown) may be deployed in or in association with communication devices through which OTT connection 950 passes; the sensors may participate in the measurement procedure by supplying values of the monitored quantities exemplified above or supplying values of other physical quantities from which software 911, 931 may compute or estimate the monitored quantities. The reconfiguring of OTT connection 950 may include message format, retransmission settings, preferred routing etc.; the reconfiguring need not affect base station 920, and it may be unknown or imperceptible to base station 920. Such procedures and functionalities may be known and practiced in the art. In certain embodiments, measurements may involve proprietary UE signaling facilitating host computer 910's measurements of throughput, propagation times, latency and the like. The measurements may be implemented in that software 911 and 931 causes messages to be transmitted, in particular empty or ‘dummy’ messages, using OTT connection 950 while it monitors propagation times, errors etc.

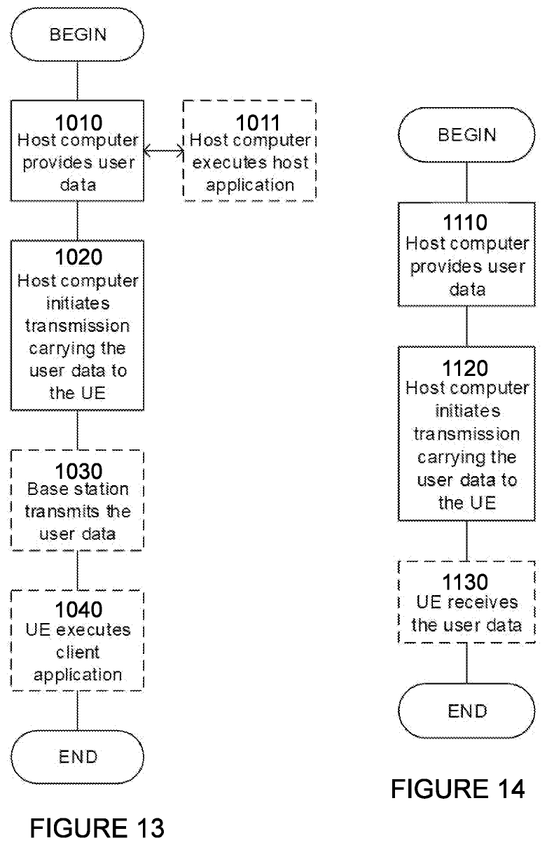

FIG. 13 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 13 will be included in this section. In step 1010, the host computer provides user data. In substep 1011 (which may be optional) of step 1010, the host computer provides the user data by executing a host application. In step 1020, the host computer initiates a transmission carrying the user data to the UE. In step 1030 (which may be optional), the base station transmits to the UE the user data which was carried in the transmission that the host computer initiated, in accordance with the teachings of the embodiments described throughout this disclosure. In step 1040 (which may also be optional), the UE executes a client application associated with the host application executed by the host computer.

FIG. 14 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 14 will be included in this section. In step 1110 of the method, the host computer provides user data. In an optional substep (not shown) the host computer provides the user data by executing a host application. In step 1120, the host computer initiates a transmission carrying the user data to the UE. The transmission may pass via the base station, in accordance with the teachings of the embodiments described throughout this disclosure. In step 1130 (which may be optional), the UE receives the user data carried in the transmission.

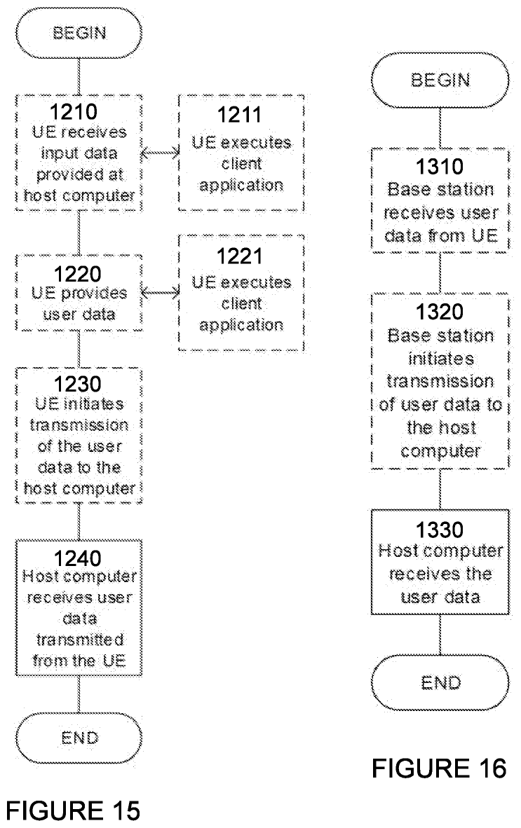

FIG. 15 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 15 will be included in this section. In step 1210 (which may be optional), the UE receives input data provided by the host computer. Additionally or alternatively, in step 1220, the UE provides user data. In substep 1221 (which may be optional) of step 1220, the UE provides the user data by executing a client application. In substep 1211 (which may be optional) of step 1210, the UE executes a client application which provides the user data in reaction to the received input data provided by the host computer. In providing the user data, the executed client application may further consider user input received from the user. Regardless of the specific manner in which the user data was provided, the UE initiates, in substep 1230 (which may be optional), transmission of the user data to the host computer. In step 1240 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 16 will be included in this section. In step 1310 (which may be optional), in accordance with the teachings of the embodiments described throughout this disclosure, the base station receives user data from the UE. In step 1320 (which may be optional), the base station initiates transmission of the received user data to the host computer. In step 1330 (which may be optional), the host computer receives the user data carried in the transmission initiated by the base station.

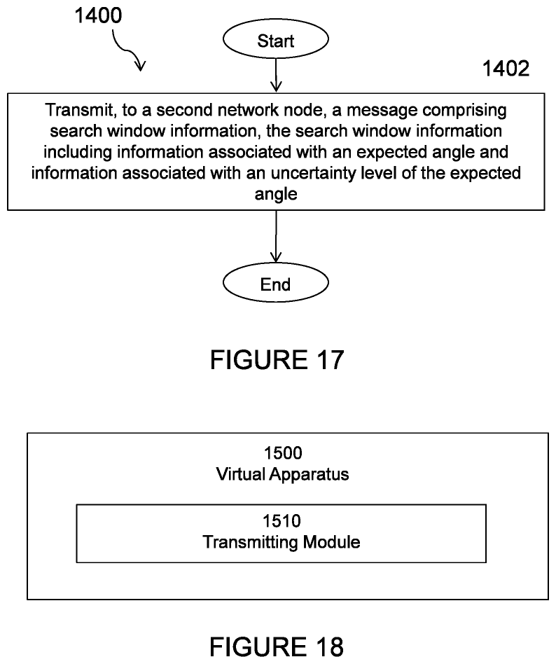

FIG. 17 depicts a method 1400 by a first network node, according to certain embodiments. At step 1402, the first network node transmits, to a second network node, a message comprising search window information. The search window information includes information associated with an expected angle and information associated with an uncertainty level of the expected angle. In a particular embodiment, the first network node comprises a LMF 120 and the second network node comprises a gNB or TRP 110-115.

In various particular embodiments, the method may additionally or alternatively include one or more of the steps or features of the Group A and Group E Examples described below.

FIG. 18 illustrates a schematic block diagram of a virtual apparatus 1500 in a wireless network (for example, the wireless network shown in FIG. 6). The apparatus may be implemented in a wireless device or network node (e.g., wireless device 510 or network node 560 shown in FIG. 6). Apparatus 1500 is operable to carry out the example method described with reference to FIG. 17 and possibly any other processes or methods disclosed herein. It is also to be understood that the method of FIG. 17 is not necessarily carried out solely by apparatus 1500. At least some operations of the method can be performed by one or more other entities.

Virtual Apparatus 1500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 1510 and any other suitable units of apparatus 1500 to perform corresponding functions according one or more embodiments of the present disclosure.

According to certain embodiments, transmitting module 1510 may perform certain of the transmitting functions of the apparatus 1500. For example, transmitting module 1510 may transmit, to a another network node, a message comprising search window information. The search window information includes information associated with an expected angle and information associated with an uncertainty level of the expected angle. In a particular embodiment, the transmitting module 1510 may be associated with a LMF and the other network node may be a gNB or TRP.

Optionally, in particular embodiments, virtual apparatus may additionally include one or more modules for performing any of the steps or providing any of the features in the Group A and Group E Example Embodiments described below.

As used herein, the term module or unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

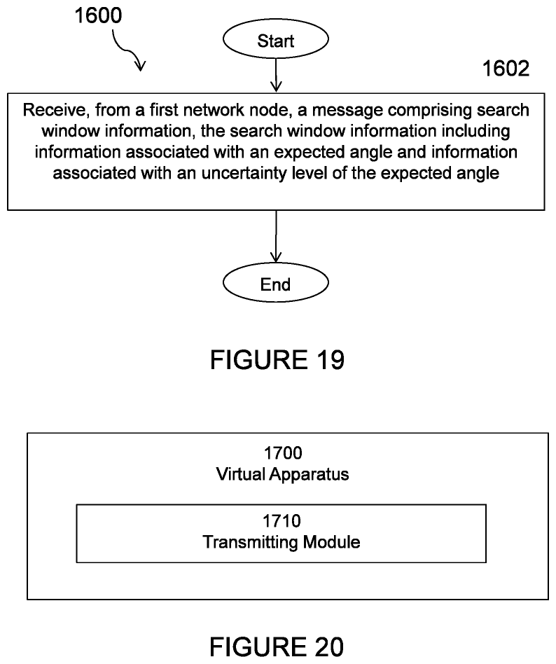

FIG. 19 depicts a method 1600 by a second network node, according to certain embodiments. At step 1602, the first network node receives, from a first network node, a message comprising search window information. The search window information includes information associated with an expected angle and information associated with an uncertainty level of the expected angle. In a particular embodiment, the second network node comprises a gNB or TRP 110-115 and the first network node comprises a LMF 120.

In various particular embodiments, the method may include one or more of any of the steps or features of the Group B and Group E Examples described below.

FIG. 20 illustrates a schematic block diagram of a virtual apparatus 1700 in a wireless network (for example, the wireless network shown in FIG. 3). The apparatus may be implemented in a wireless device or network node (e.g., wireless device 50 or network node 560 shown in FIG. 6). Apparatus 1700 is operable to carry out the example method described with reference to FIG. 19 and possibly any other processes or methods disclosed herein. It is also to be understood that the method of FIG. 19 is not necessarily carried out solely by apparatus 1700. At least some operations of the method can be performed by one or more other entities.

Virtual Apparatus 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1710 and any other suitable units of apparatus 1700 to perform corresponding functions according one or more embodiments of the present disclosure.

According to certain embodiments, receiving module 1710 may perform certain of the receiving functions of the apparatus 1700. For example, receiving module 1710 may receive, from another network node, a message comprising search window information. The search window information includes information associated with an expected angle and information associated with an uncertainty level of the expected angle. In a particular embodiment, the receiving module 1710 may be associated with a gNB or TRP 110-115 and the other network node may be a LMF 120.

Optionally, in particular embodiments, virtual apparatus may additionally include one or more modules for performing any of the steps or providing any of the features in the Group B and Group E Examples described below.

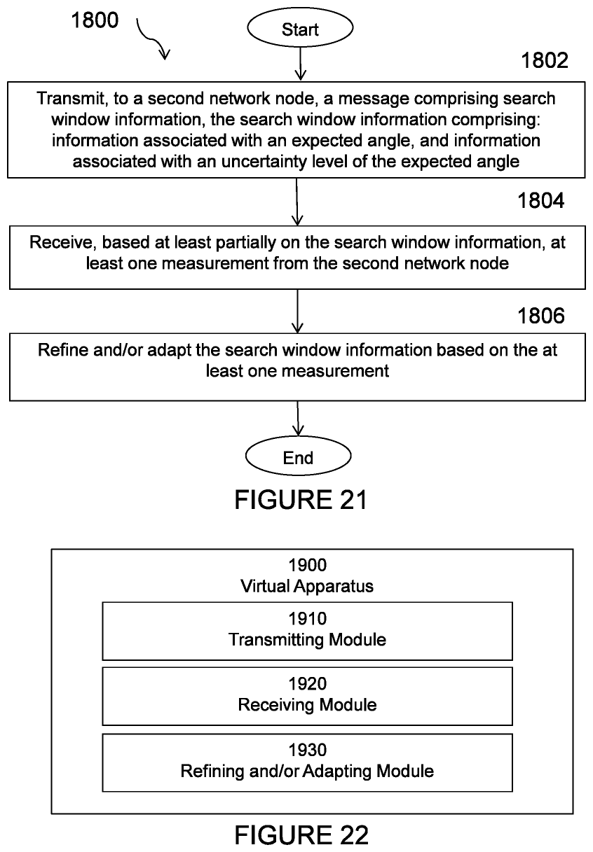

FIG. 21 depicts a method 1800 by a first network node, according to certain embodiments. At step 1802, the first network node transmits, to a second network node, a message comprising search window information. The search window information comprises information associated with an expected angle, and information associated with an uncertainty level of the expected angle. At step 1804, the first network node receives, based at least partially on the search window information, at least one measurement from the second network node. At step 1806, the first network node refines and/or adapts the search window information based on the at least one measurement.

In various particular embodiments, the method may additionally or alternatively include one or more of the steps or features of the Group C and Group E Examples described below.

FIG. 22 illustrates a schematic block diagram of a virtual apparatus 1900 in a wireless network (for example, the wireless network shown in FIG. 6). The apparatus may be implemented in a wireless device or network node (e.g., wireless device 510 or network node 560 shown in FIG. 6). Apparatus 1900 is operable to carry out the example method described with reference to FIG. 21 and possibly any other processes or methods disclosed herein. It is also to be understood that the method of FIG. 21 is not necessarily carried out solely by apparatus 1900. At least some operations of the method can be performed by one or more other entities.

Virtual Apparatus 1900 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 1910, receiving module 1920, refining and/or adapting module 1930, and any other suitable units of apparatus 1900 to perform corresponding functions according one or more embodiments of the present disclosure.

According to certain embodiments, transmitting module 1910 may perform certain of the transmitting functions of the apparatus 1900. For example, transmitting module 1910 may transmit, to a second network node, a message comprising search window information. The search window information comprises information associated with an expected angle, and information associated with an uncertainty level of the expected angle.

According to certain embodiments, receiving module 1920 may perform certain of the receiving functions of the apparatus 1900. For example, receiving module 1920 may receive, based at least partially on the search window information, at least one measurement from the second network node.

According to certain embodiments, refining and/or adapting module 1930 may perform certain of the refining and/or adapting functions of the apparatus 1900. For example, refining and/or adapting module 1930 may refine and/or adapt the search window information based on the at least one measurement.

Optionally, in particular embodiments, virtual apparatus may additionally include one or more modules for performing any of the steps or providing any of the features in the Group C and Group E Examples described below.

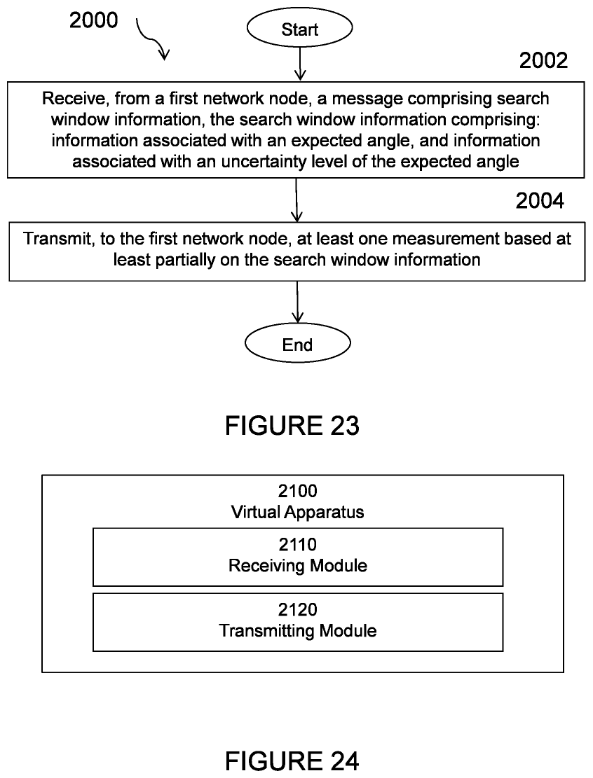

FIG. 23 depicts a method by a second network node, according to certain embodiments. At step 2002, the second network node receives, from a first network node, a message comprising search window information. The search window information includes: information associated with an expected angle and information associated with an uncertainty level of the expected angle. At step 204, the second network node transmits, to the first network node, at least one measurement based at least partially on the search window information.

In various particular embodiments, the method may include one or more of any of the steps or features of the Group D and Group E Examples described below.

FIG. 24 illustrates a schematic block diagram of a virtual apparatus 2100 in a wireless network (for example, the wireless network shown in FIG. 6). The apparatus may be implemented in a wireless device or network node (e.g., wireless device 510 or network node 560 shown in FIG. 6). Apparatus 2100 is operable to carry out the example method described with reference to FIG. 23 and possibly any other processes or methods disclosed herein. It is also to be understood that the method of FIG. 23 is not necessarily carried out solely by apparatus 2100. At least some operations of the method can be performed by one or more other entities.

Virtual Apparatus 2100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 2110, transmitting module 2120, and any other suitable units of apparatus 2100 to perform corresponding functions according one or more embodiments of the present disclosure.

According to certain embodiments, receiving module 2110 may perform certain of the receiving functions of the apparatus 2100. For example, receiving module 2110 may receive, from a first network node, a message comprising search window information. The search window information includes information associated with an expected angle and information associated with an uncertainty level of the expected angle.

According to certain embodiments, transmitting module 2120 may perform certain of the transmitting functions of the apparatus 2100. For example, transmitting module 2110 may transmit, to the first network node, at least one measurement based at least partially on the search window information.

Optionally, in particular embodiments, virtual apparatus may additionally include one or more modules for performing any of the steps or providing any of the features in the Group D and Group E Examples described below.

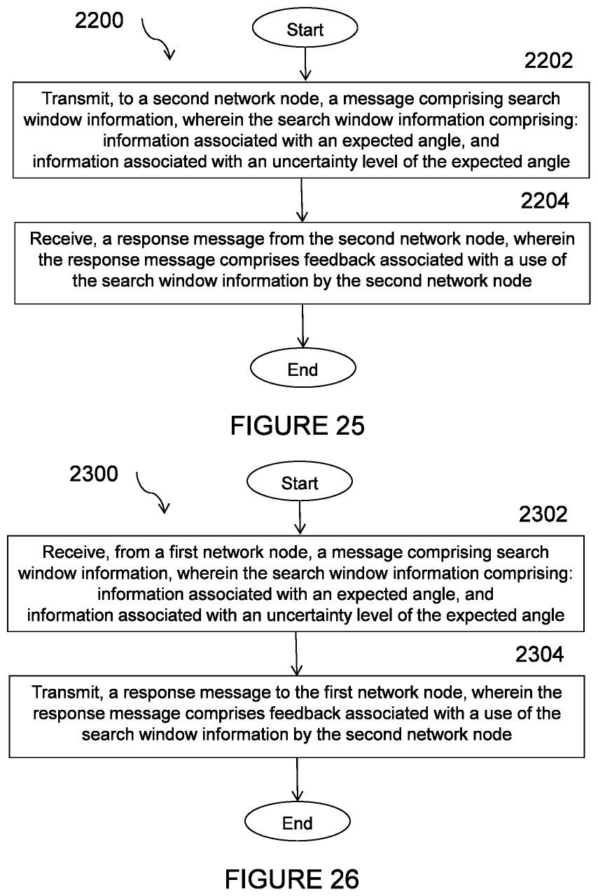

FIG. 25 illustrates a method 2200 by a first network node 560, according to certain embodiments. The method begins at step 2202 when the first network node transmits, to a second network node 560, a message comprising search window information. The search window information includes information associated with an expected angle and information associated with an uncertainty level of the expected angle. At step 2204, the first network node 560 receives a response message from the second network node 560. The response message comprises feedback associated with a use of the search window information by the second network node 560.

It is generally recognized that the term search window information, as used herein, includes and/or may also be replaced with the term “AoA search window information” and/or “AoA assistance information.”

In a particular embodiment, the feedback associated with the use of the search window information indicates at least one of: how the search window information was used by the second network node 560, and whether the search window information was used by the second network node 560.

In a particular embodiment, the feedback is indicated as a flag.

In a particular embodiment, the feedback indicates: a usable reference signal was received based on the search window information, or a usable reference signal was not found based on the search window information.

In a particular embodiment, the first network node 560 receives, based at least partially on the search window information, at least one measurement from the second network node. The first network node 560 refines and/or adapts the search window information based on the at least one measurement.

In a particular embodiment, the message comprises a NRPPA measurement request message, and the response message comprises NRPPA measurement response message. In this scenario, the first network node comprises a location server, and the second network node comprises a CU.

In another particular embodiment, the message comprises a F1 Positioning Measurement Request message, the first network node comprises a CU, and the second network node comprises a DU.

In a particular embodiment, the information associated with the expected angle comprises at least one of: an expected AoA, and an expected ZoA.

In a particular embodiment, the information associated with the uncertainty level of the expected angle indicates: a value representing a level of uncertainty of the expected angle, or that the first network node has no knowledge of the a level of uncertainty of the expected angle.

In a particular embodiment, the message comprises SRS configuration information for performance of at least one measurement by the second network node, and at least one measurement comprises at least one of: an UL-RTOA measurement, an UL RTT measurement, an e-CID measurement, an AoA measurement, and an ZoA measurement.

In a particular embodiment, the first network node 560 receives a request for the search window information from the second network node 560, and wherein the search window information is included in the message based on the request for the search window information.

In a particular embodiment, the response message comprises at least one of: a Physical Cell Identifier of at least one measurement, a Cell Global Identifier of at least one measurement, a Transmission and Reception Point Identifier of at least one measurement; an uplink AoA; an Uplink Sounding Reference Signal-Reference Signal Received Power; a time stamp associated with at least one measurement; and a quality level associated with at least one measurement.

In a particular embodiment, the response message comprises indicates that the second network node 560 used a search window that is different from the search window information.

In a particular embodiment, the first network node 560 adapts the search window information based on the response message and transmits the adapted search window information to the second network node 560.

FIG. 26 illustrates a method 2300 by a second network node 560, according to certain embodiments. The method begins at step 2302 when the second network node 560 receives, from a first network node 560, a message comprising search window information. The search window information includes information associated with an expected angle, and information associated with an uncertainty level of the expected angle. The second network node 560 transmits a response message to the first network node 560. The response message comprises feedback associated with a use of the search window information by the first network node 560.

It is generally recognized that the term search window information, as used herein, includes and/or may also be replaced with the term “AoA search window information” and/or “AoA assistance information.”

In a particular embodiment, the feedback associated with the use of the search window information indicates at least one of: how the search window information was used by the second network node 560, and whether the search window information was used by the second network node 560.

In a particular embodiment, the feedback is indicated as a flag.

In a particular embodiment, the feedback indicates: a usable reference signal was received based on the search window information, or a usable reference signal was not found based on the search window information.

In a particular embodiment, the second network node 560 transmits, based at least partially on the search window information, at least one measurement to the first network node 560. The second network node 560 receives, from the first network node 560, additional search window information that is adapted based on the at least one measurement.

In a particular embodiment, the message comprises a NRPPA measurement request message, the response message comprises NRPPA measurement response message, the first network node comprises a location server, and the second network node comprises a CU.

In a particular embodiment, the message comprises a F1 Positioning Measurement Request message, the first network node comprises a CU, and the second network node comprises a DU.

In a particular embodiment, the angle information associated with the expected angle comprises at least one of: an expected AoA and an expected ZoA.

In a particular embodiment, the information associated with the uncertainty level of the expected angle indicates: a value representing a level of uncertainty of the expected angle, or that the second network node has no knowledge of the a level of uncertainty of the expected angle.

In a particular embodiment, the message comprises SRS configuration information for performance of at least one measurement by the second network node 560.

In a particular embodiment, the second network node 560 performs the at least one measurement based on at least one of: the configuration information and the search window information.

In a particular embodiment, at least one measurement comprises at least one of: an UL-RTOA measurement, an UL RTT measurement, an e-CID measurement, an AoA measurement, and an ZoA measurement.

In a particular embodiment, the response message comprises at least one of: a Physical Cell Identifier of at least one measurement, a Cell Global Identifier of at least one measurement, a Transmission and Reception Point Identifier of at least one measurement; an uplink AoA; an Uplink Sounding Reference Signal-Reference Signal Received Power; a time stamp associated with at least one measurement; and a quality level associated with at least one measurement.

In a particular embodiment, the response message comprises indicates that the first network node 560 used a search window that is different from the search window information.

In a particular embodiment, the second network node 560 transmits a request for the search window information to the first network node 560, and the search window information is included in the message based on the request for the search window information.

### Additional Information

Enhancements have been proposed for UL-AoA positioning solutions. For example, accuracy improvements have been made to Doppler reporting and UL-AoA.

The UL-AoA of signals from a moving UE can be estimated from the measured doppler shift and the UE velocity vector. Since such estimate is independent of other methods for UL-AoA estimation it can be valuable in an information fusion context.

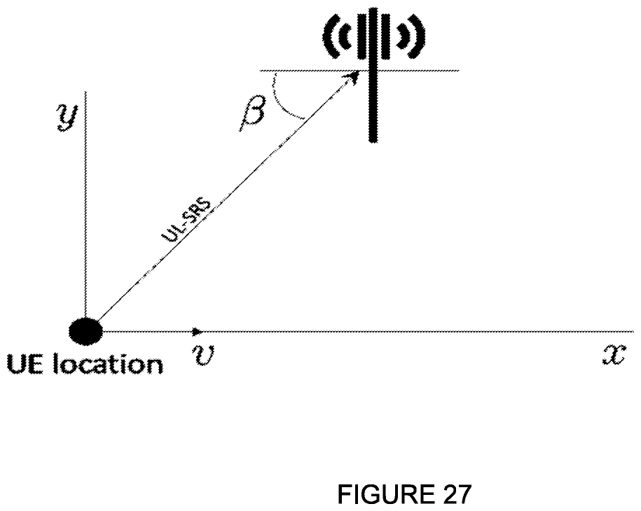

As shown in the FIG. 27, for simplicity sake shown in 2-D, an uplink SRS has an arrival angle “β” at the TRP. The UE is moving with a velocity “v”. The TRP can estimate the angle of arrival from the following expression,

$${f}_{D} = \frac{v}{{λ}_{c}} cos β$$

Above, f_{D} is the Doppler frequency, A, is the wavelength corresponding to the transmitted carrier frequency and v is the velocity of the UE.
Observation 1: Angle of arrival of UL-SRS transmitted by a UE at TRP can be estimated if the velocity of the UE and carrier frequency is known.
Proposal 1: For estimating AoA at TRPs, velocity of the UE should be reported to the network.

As another example, assistance data may be used to facilitate UL measurement of UL AoA. During RAN1 #104b the following was agreed:
NR supports at least the following additional assistance signaling from LMF to gNB/TRP to facilitate UL measurements of UL-AOA
   Indication of expected AoA/ZoA value and uncertainty (of the expected AoA/ZoA value) range(s)
   For Future Study (FFS): Details of procedure for providing the assistance
   FFS: Reference angle of expected AoA/ZoA

The discussion on the reference angle of expected AoA/ZoA did not converge during the meeting and was left FFS. From the gNB perspective, the reference angle of the expected AoA depends on the coordinate system (either global coordinates (GCS) or local coordinates (LCS) can be used). Since the gNB can translate GCS to LCS if needed, the LMF should only have to provide the expected AoA/ZoA in GCS.

Regarding the details of the procedure for providing the expected AoA/ZoA and uncertainty window, there are two aspects to be discussed:
Whether the gNB should always expect the expected AoA/ZoA and uncertainty window to be transmitted
Whether the gNB needs to receive the expected AoA/ZoA and uncertainty window every time the SRS is requested to be measured/reported, or if it should receive it only for the first measurement/report.
   Both issues are suitable for RAN3 discussions. For UL-RTOA, the time window is signalled to the gNB as part of the configuration information sent in the first measurement request and can also be updated by the LMF via measurement update messages. In the same fashion, we propose that the expected angle window may also be updated by the LMF.

Since the gNB may not require this signalling, it is important that the LMF knows in advance whether the gNB should receive expected AoA/ZoA and uncertainty window. Therefore, also it is also proposed that the gNB may send as part of the initial steps of the AoA procedures (e.g. when transmitting SRS configurations) that it will require the expected AoA/ZoA and uncertainty window.
Proposal 2: The gNB can signal that it requires an expected AoA/ZoA and uncertainty window
Proposal 3: The expected AoA/ZoA and uncertainty window is provided by the LMF to the gNB in GCS.
Proposal 4: The gNB can be (optionally) provided with the expected AoA/ZoA and uncertainty window during initial LMF measurement request message, as part of the SRS configuration. The LMF can also provide (optional) updates on the expected AoA/ZoA and uncertainty window as part of the measurement update message. RAN3 can discuss the details of the request procedure.

Sending a measurement window is prevalent in timing-based measurements. In timing measurements, the true value of the time to be measured lies within useful bounded interval. However, for angle measurements, the true measurement due to the nature of scattering may be random and distributed over the whole range from 0 to 360 degrees. Therefore, we propose that the LMF may only signal the expected AoA without the uncertainty window when the window would span 360 degrees. Furthermore, the uncertainty window can be computed by the LMF using various input and the reliability of the window can differ based on what was available to the LMF. Therefore, it is propose to also signal a quality indicator as part of the expected AoA/ZoA and uncertainty window message.
Proposal 5: When the LMF sends the expected AoA/ZoA and uncertainty window, the uncertainty window can be omitted by the gNB.
Proposal 6: The LMF includes a quality indicator as part of the message containing the expected AoA/ZoA and uncertainty window

Additionally, it is important that the procedure allows the gNodeB to respond to the LMF to correct the angle window. Clearly, the measured AoA allows to correct the expected AoA. Similarly, it should be possible for the gnodeB to correct the uncertainty window. The LMF could have an erroneous view of the possible angle of arrival, and provide a wrong window center or a wrong window size.

For the uncertainty window, the following feedback is useful to the LMF:
Whether the gnodeB could use the window or if it was too off-mark
What window, if any, was used by the gnodeB
Proposal 7: The gnodeB can provide an update to the uncertainty window as part of the measurement report.
FFS: details on the update (e.g. window used by the gnodeB, indicator that the window was used).
Proposal 8: Send an LS to RAN3 reflecting the NRPPa impact

As another example, reporting enhancements are proposed for a linear array antenna.

During RAN1 #104b the following was agreed:
Further study which option is used to potentially enhance signaling of UL-AOA measurement report in case of a linear array antenna
Option 1: gNB reports UL-AOA measurement which is a function of the actual azimuth and zenith angles of arrival in a given coordinate system
Option 2: The z-axis of LCS is defined along the linear array axis. gNB reports only the ZoA relative to z-axis in the LCS, and the LCS-to-GCS translation function is used to set up the specific z-axis direction

Other options are not precluded from the study. As mentioned during RAN1 #104e, in a ULA, the AoA report can only provide a meaningful measurement in one dimension. See, R1-2007577 Positioning enhancement in Rel-17, Huawei, HiSilicon, RAN1 #103e. Since the antenna is a ULA, elevation information is not available. Based on RSRP and the measured AoA, the gNB can only report a cone of uncertainty for the UE location, centered along the antenna axis.

Both of the options proposed in RAN1 #104e would be suitable, as long as the LMF knows that the geometry of the measuring antenna is ULA. In option 1, nodeB will translate the ULA angle measurement into a AoA/ZoA (translating Beta into a alpha/gamma pair) which in turn will be transmitted to the LMF. However, the network gNB should also signal to the LMF that the measurement originates from an ULA-based measurement so that the LMF can consider the “cone of uncertainty” for the measurement. In option 2, the measurement is already using the nodeB Antenna as the reference z-axis. However the LMF needs to translate it back to GCS in order to fuse all the measurements from different gNBs. Moreover, the measurement report needs to be re-defined to only feature the ZoA. Therefore, since the two options seem to have the same complexity for the network, there is a preference for option 1, which does not have impact on the measurement report format. The only additional required information is that the LMF should know the antenna is of the ULA type.
Proposal 9: When the gNodeB antenna is a uniform linear array antenna, gNB reports UL-AOA measurements which is a function of the actual azimuth and zenith angles of arrival in a given coordinate system (Option 1 in RAN1 #104e).

As another example, reporting enhancements are proposed for additional paths.

During RAN1 #104b the following was agreed:
NR supports reporting of M>1 UL-AOA (AoA/ZoA) measurement values by gNB to the LMF at least for the first arrival path
   FFS: Supporting of UL-AOA measurements for additional paths
   FFS: Supporting of N>=1 UL-AOA values per path for additional paths
   FFS: Whether the multiple values can correspond to the same time stamp.
FFS: Further details of measurement and reporting
Note: The reporting by gNB to the LMF is optional

Information of the UL-AOA (AoA/ZoA) for other paths than the first path can also improve positioning accuracy. Especially in controlled environments like industry halls can ray tracing and/or machine learning algorithms utilize such information for positioning purposes. Reporting of UL-AOA measurements for additional paths is supported. Since additional paths are more useful for such purposes the stronger they are, it is proposed that the gNB should report the strongest detected paths as additional paths. As this is a gNB measurement, many paths could be reported.

Observation 2: signalling from gNB could allow for large number of paths.

The benefit of reporting more than one UL-AoA measurement for the first arrival path is that the gNB can report AoA for different SRS resources and different receiving beams or antenna panels. For additional paths to be useful, there must always be an initial path measured. Therefore, the number N of values per additional path cannot exceed the number M of values for the first arrival path.
Proposal 10: Support reporting multiple AoA measurement per path (first or additional) within one time stamp
Proposal 11: The maximum number of measurement per path is the same for first and additional path.

In conclusion, the following observations were made:
Observation 1 Angle of arrival of UL-SRS transmitted by a UE at TRP can be estimated if the velocity of the UE and carrier frequency is known.
Observation 2 signalling from gnodeB could allow for large number of paths.

Based on the discussion in the previous sections the following is proposed:
Proposal 1 For estimating AoA at TRPs, velocity of the UE should be reported to the network.
Proposal 2 The gnodeB can signal that it requires an expected AoA/ZoA and uncertainty window
Proposal 3 The expected AoA/ZoA and uncertainty window is provided by the LMF to the gnodeB in GCS.
Proposal 4 The gnodeB can be (optionally) provided with the expected AoA/ZoA and uncertainty window during initial LMF measurement request message, as part of the SRS configuration. The LMF can also provide (optional) updates on the expected AoA/ZoA and uncertainty window as part of the measurement update message. RAN3 can discuss the details of the request procedure.
Proposal 5 When the LMF sends the expected AoA/ZoA and uncertainty window, the uncertainty window can be omitted.
Proposal 6 The LMF includes a quality indicator as part of the message containing the expected AoA/ZoA and uncertainty window
Proposal 7 The gnodeB can provide an update to the uncertainty window as part of the measurement report.
   FFS: details on the update (e.g. window used by the gnodeB, indicator that the window was used).
Proposal 8 Send an LS to RAN3 reflecting the NRPPa impact
Proposal 9 When the gNodeB antenna is a uniform linear array antenna, gNB reports UL-AOA measurements which is a function of the actual azimuth and zenith angles of arrival in a given coordinate system (Option 1 in RAN1 #104e).
Proposal 10 Support reporting multiple AoA measurement per path (first or additional) within one time stamp
Proposal 11 The maximum number of measurement per path is the same for first and additional path.

### EXAMPLES

Example A1. A method by a first network node comprising: transmitting, to a second network node, a message comprising search window information, the search window information comprising: information associated with an expected angle, and information associated with an uncertainty level of the expected angle.

Example A2. The method of Example A1, wherein the angle information associated with the expected angle comprises at least one of: an expected Azimuth of Arrival (AoA) and an expected Zenith of Arrival (ZoA).

Example A3. The method of any one of Example A1 to A2, wherein the information associated with the uncertainty level of the expected angle indicates a value representing a level of uncertainty of the expected angle.

Example A4. The method of any one of Examples A1 to A2, wherein the information associated with the uncertainty level of the expected angle indicates that the first network node has no knowledge of the a level of uncertainty of the expected angle.

Example A5. The method of any one of Examples A1 to A4, wherein the search window information comprises a pair {μ, σ} where μ is the expected angle and σ the uncertainty level of the expected angle.

Example A6. The method of Example A5, wherein each of μ, σ can be integers ranging from 0 to N-1 so that their resolution is 360/N degrees.

Example A7. The method of any one of Examples A1 to A6, wherein the search window information comprises a pair {k₁, k₂} where k₁ is a lower bound of a window and k₂ is an upper bound of the window.

Example A8. The method of Example A7, wherein each of {k₁, k₂} can be integers ranging from 0 to N-1 so that their resolution is 360/N degrees.

Example A9. The method of any one of Examples A1 to A8, wherein the search window information comprises a list of sub-windows.

Example A10. The method of any one of Examples A1 to A9, wherein the message comprises a measurement request message.

Example A11. The method of any one of Examples A1 to A10, wherein the search window information comprises a search window information element (IE) (i.e., AoA search window information).

Example A12. The method of any one of Examples A1 to A11, wherein the message comprises configuration information for performance of at least one measurement by the second network node.

Example A13. The method of Example A12, wherein the configuration information comprises a Sounding Reference Signal (SRS) configuration.

Example A14. The method of any one of Examples A12 to A13, wherein at least one measurement comprises at least one of: an Uplink Relative Time of Arrival (UL-RTOA) measurement, an Uplink Round-Trip-Time (UL RTT) measurement, an Enhanced Cell-ID (e-CID) measurement, an AoA measurement, and an ZoA measurement.

Example A15. The method of any one of Examples A1 to A14, further comprising autonomously determining by the first network node to include the search window information in the message.

Example A16. The method of Example A15, wherein autonomously determining to include the search window information in the message is based on receiving information from the second network node that the second network node used previously provided search window information.

Example A17. The method of any one of Examples A1 to A14, further comprising: receiving a request for the search window information from the second network node, and wherein the search window information is included in the message based on the request for the search window information.

Example A18. The method of Example A17, wherein the request for the search window information is received in a message from the second network node during an initial exchange of configuration information between the first network node and second network node.

Example A19. The method of Example A17, wherein the configuration information comprises a Sounding Reference Signal (SRS) configuration.

Example A20. The method of any one of Examples A1 to A19, further comprising receiving a response message from the second network node.

Example A21. The method of Example A20, wherein the response message comprises at least one of: PCI, CGI, and/or TRP ID of at least one measurement; an UL AoA; an Uplink Sounding Reference Signal-Reference Signal Received Power (UL SRS-RSRP); a time stamp associated with at least one measurement; and a quality level associated with at least one measurement.

Example A22. The method of any one of Examples A20 to A21, wherein the response message comprises a NRPPA measurement response message.

Example A23. The method of any one of Examples A20 to A22, wherein the response message comprises feedback associated with how and/or whether the search window information was used by the second network node.

Example A24. The method of Example A23, wherein the feedback is indicated as a Boolean flag.

Example A25. The method of any one of Examples A23 to A24, wherein the feedback indicates that a usable reference signal was received based on the search window information.

Example A26. The method of any one of Examples A23 to A24, wherein the feedback indicates that a usable reference signal was not found based on the search window information.

Example A27. The method of any one of Examples A23 to A26, wherein the feedback indicates an actual search window used by the second network node, the actual search window represented as a pair {μ, σ} where μ is an actual angle and σ the uncertainty level of the expected angle.

Example A28. The method of Example A27, wherein each of μ, σ can be integers ranging from 0 to N-1 so that their resolution is 360/N degrees.

Example A29. The method of any one of Examples A23 to A28, wherein the feedback indicates an actual search window used by the second network node, the actual search window represented as a pair {k₁, k₂} where k₁ is a lower bound of the actual search window and k₂ is an upper bound of the actual search window.

Example A30. The method of Example A29, wherein each of {k₁, k₂} can be integers ranging from 0 to N-1 so that their resolution is 360/N degrees.

Example A31. The method of any one of Examples A23 to A30, wherein the feedback comprises a list of actual sub-windows.

Example A32. The method of any one of Examples A20 to A31, wherein the response message comprises indicates that the second network node used a search window that is different from the search window information.

Example A33. The method of any one of Examples A20 to A32, wherein the response message comprises: at least one measurement generated using the search window information from the first network node, and/or at least one measurement generated using the search window that is different from the search window information.

Example A34. The method of any one of Examples A20 to A33, further comprising refining and/or adapting the search window information based on the response message.

Example A35. The method of Example A34, further comprising transmitting the refined and/or adapted search window information to the second network node.

Example A36. The method of any one of Examples A1 to A35, wherein the first network node comprises a Location Management Function.

Example A37. The method of any one of Examples A1 to A36, wherein the second network node comprises a gNodeB (gNB) or a Transmission and Reception Point (TRP).

Example A38. A first network node comprising processing circuitry configured to perform any of the methods of Examples A1 to A37.

Example A39. A computer program comprising instructions which when executed on a computer perform any of the methods of Examples A1 to A39.

Example A40. A computer program product comprising computer program, the computer program comprising instructions which when executed on a computer perform any of the methods of Examples A1 to A39.

Example A41. A non-transitory computer readable medium storing instructions which when executed by a computer perform any of the methods of Examples A1 to A39.

Example B1. A method by a first network node comprising: receiving, from a second network node, a message comprising search window information, the search window information comprising: information associated with an expected angle, and information associated with an uncertainty level of the expected angle.

Example B2. The method of Example B1, wherein the angle information associated with the expected angle comprises at least one of: an expected Azimuth of Arrival (AoA) and an expected Zenith of Arrival (ZoA).

Example B3. The method of any one of Examples B1 to B2, wherein the information associated with the uncertainty level of the expected angle indicates a value representing a level of uncertainty of the expected angle.

Example B4. The method of any one of Examples B1 to B2, wherein the information associated with the uncertainty level of the expected angle indicates that the first network node has no knowledge of the a level of uncertainty of the expected angle.

Example B5. The method of any one of Examples B1 to B4, wherein the search window information comprises a pair {μ, σ} where μ is the expected angle and σ the uncertainty level of the expected angle.

Example B6. The method of Example B5, wherein each of μ, σ can be integers ranging from 0 to N-1 so that their resolution is 360/N degrees.

Example B7. The method of any one of Examples B1 to B6, wherein the search window information comprises a pair {k₁, k₂} where k₁ is a lower bound of a window and k₂ is an upper bound of the window.

Example B8. The method of Example B7, wherein each of {k₁, k₂} can be integers ranging from 0 to N-1 so that their resolution is 360/N degrees.

Example B9. The method of any one of Examples B1 to B8, wherein the search window information comprises a list of sub-windows.

Example B10. The method of any one of Examples B1 to B9, wherein the message comprises a measurement request message.

Example B11. The method of any one of Examples B1 to B10, wherein the search window information comprises a search window information element (IE) (i.e., AoA search window information).

Example B12. The method of any one of Examples B1 to B11, wherein the message comprises configuration information for performance of at least one measurement by the first network node.

Example B13. The method of Example B12, wherein the configuration information comprises a Sounding Reference Signal (SRS) configuration.

Example B14. The method of any one of Examples B12 to B13, further comprising performing the at least one measurement based on at least one of: the configuration information and the search window information.

Example B15. The method of any one of Examples B12 to A14, wherein at least one measurement comprises at least one of: an Uplink Relative Time of Arrival (UL-RTOA) measurement, an Uplink Round-Trip-Time (UL RTT) measurement, an Enhanced Cell-ID (e-CID) measurement, an AoA measurement, and an ZoA measurement.

Example B16. The method of any one of Examples B12 to B15, further comprising transmitting a response message to the second network node.

Example B17. The method of Example B16, wherein the response message comprises at least one of: PCI, CGI, and/or TRP ID of at least one measurement; an UL AoA; an Uplink Sounding Reference Signal-Reference Signal Received Power (UL SRS-RSRP); a time stamp associated with at least one measurement; and a quality level associated with at least one measurement.

Example B18. The method of any one of Examples B16 to B17, wherein the response message comprises a NRPPA measurement response message.

Example B19. The method of any one of Examples B16 to B18, wherein the response message comprises feedback associated with how and/or whether the search window information was used by the first network node.

Example B20. The method of Example B19, wherein the feedback is indicated as a Boolean flag.

Example B21. The method of any one of Examples B19 to B20, wherein the feedback indicates that a usable reference signal was received by the first network node based on the search window information.

Example B22. The method of any one of Examples B19 to B20, wherein the feedback indicates that a usable reference signal was not found by the first network node based on the search window information.

Example B23. The method of any one of Examples B19 to B22, wherein the feedback indicates an actual search window used by the first network node, the actual search window represented as a pair {μ, σ} where μ is an actual angle and σ the uncertainty level of the expected angle.

Example B24. The method of Example B23, wherein each of μ, σ can be integers ranging from 0 to N-1 so that their resolution is 360/N degrees.

Example B25. The method of any one of Examples B19 to B24, wherein the feedback indicates an actual search window used by the first network node, the actual search window represented as a pair {k₁, k₂} where k₁ is a lower bound of the actual search window and k₂ is an upper bound of the actual search window.

Example B26. The method of Example B25, wherein each of {k₁, k₂} can be integers ranging from 0 to N-1 so that their resolution is 360/N degrees.

Example B27. The method of any one of Examples B19 to B26, wherein the feedback comprises a list of actual sub-windows.

Example B28. The method of any one of Examples B16 to B27, wherein the response message comprises indicates that the first network node used a search window that is different from the search window information.

Example B29. The method of any one of Examples B16 to B28, wherein the response message comprises: at least one measurement generated using the search window information from the second network node, and/or at least one measurement generated using the search window that is different from the search window information.

Example B30. The method of any one of Examples B16 to B29, further comprising receiving, from the second network node, refined and/or adapted search window information based on the response message.

Example B31. The method of any one of Examples B1 to B30, further comprising: transmitting a request for the search window information to the second network node, and wherein the search window information is included in the message based on the request for the search window information.

Example B32. The method of Example B31, wherein the request for the search window information is transmitted in a message to the second network node during an initial exchange of configuration information between the first network node and second network node.

Example B33. The method of Example B32, wherein the configuration information comprises a Sounding Reference Signal (SRS) configuration.

Example B34. The method of any one of Examples B1 to B33, wherein the first network node comprises a gNodeB (gNB) or a Transmission and Reception Point (TRP).

Example B35. The method of any one of Examples B1 to B34, wherein the second network node comprises a Location Management Function (LMF).

Example B36. A first network node comprising processing circuitry configured to perform any of the methods of Examples B1 to B35.

Example B37. A computer program comprising instructions which when executed on a computer perform any of the methods of Examples B1 to B35.

Example B38. A computer program product comprising computer program, the computer program comprising instructions which when executed on a computer perform any of the methods of Examples B1 to B35.

Example B39. A non-transitory computer readable medium storing instructions which when executed by a computer perform any of the methods of Examples B1 to B35.

Example C1. A method by a first network node comprising: transmitting, to a second network node, a message comprising search window information, the search window information comprising: information associated with an expected angle, and information associated with an uncertainty level of the expected angle; receiving, based at least partially on the search window information, at least one measurement from the second network node; and refining and/or adapting the search window information based on the at least one measurement.

Example C2a. The method of Example C1, wherein the angle information associated with the expected angle comprises at least one of: an expected Azimuth of Arrival (AoA) and an expected Zenith of Arrival (ZoA).

Example C2b. The method of any one of Examples C1 to C2a, wherein the message comprises a NRPPa Measurement Request message.

Example C2c. The method of any one of Examples C1 to C2a, wherein the message comprises a F1 Positioning Measurement Request message and wherein the network node comprises a gNodeB with a split architecture.

Example C2d. The method of any one of Examples C1 to C2c, wherein the at least one measurement comprises a plurality of measurements that are received continuously.

Example C2e. The method of any one of Examples C1 to C2c, wherein the at least one measurement comprises a plurality of measurements that are received substantially continuously.

Example C2f. The method of any one of Examples C1 to C2c, wherein the at least one measurement comprises a plurality of measurements that are received periodically.

Example C2g. The method of any one of Examples C1 to C2f, further comprising estimating the position of the wireless device based on the received at least one measurement.

Example C2h. The method of any one of Examples C1 to C2g, wherein the search window information is refined to maximize a probability that a line of sight associated with a wireless device is within a search window.

Example C2i. The method of any one of Examples C1 to C2h, wherein the search window information is refined for each TRP in an area.

Example C2j. The method of any one of Examples C1 to C2i, wherein the search window information is refined and/or adapted based on at least one location of a TRP.

Example C2k. The method of any one of Examples C1 to C2j, further comprising configuring the second network node to report only measurements that are generated within a search window associated with the search window information.

Example C2l. The method of any one of Examples C1 to C2j, further comprising configuring the second network node to report measurements that are generated within a search window associated with the search window information and measurements that are generated outside the search window associated with the search window information.

Example C2m. The method of any one of Examples C1 to C2l, further comprising receiving, from the second network node, information indicating that the second network node is configured to report only measurements that are generated within a search window associated with the search window information.

Example C2n. The method of any one of Examples C1 to C2l, further comprising receiving, from the second network node, information indicating that the second network node is configured to report measurements that are generated within a search window associated with the search window information and measurements that are generated outside the search window associated with the search window information.

Example C3. The method of any one of Examples C1 to C2n, wherein the information associated with the uncertainty level of the expected angle indicates a value representing a level of uncertainty of the expected angle.

Example C4. The method of any one of Examples C1 to C2n, wherein the information associated with the uncertainty level of the expected angle indicates that the first network node has no knowledge of the a level of uncertainty of the expected angle.

Example C5. The method of any one of Examples C1 to C4, wherein the search window information comprises a pair {μ, σ} where μ is the expected angle and σ the uncertainty level of the expected angle.

Example C6. The method of Example C5, wherein each of μ, σ can be integers ranging from 0 to N-1 so that their resolution is 360/N degrees.

Example C7. The method of any one of Examples C1 to C6, wherein the search window information comprises a pair {k₁, k₂} where k₁ is a lower bound of a window and k₂ is an upper bound of the window.

Example C8. The method of Example C7, wherein each of {k₁, k₂} can be integers ranging from 0 to N-1 so that their resolution is 360/N degrees.

Example C9. The method of any one of Examples C to C8, wherein the search window information comprises a list of sub-windows.

Example C10a. The method of any one of Examples C1 to C9, wherein the message comprises a measurement request message.

Example C10b. The method of Example C10a, further comprising transmitting a plurality of measurement request messages, each measurement request message comprising a respective one of a plurality of search windows.

Example C10c. The method of Example C10b, wherein each of the plurality of search windows is associated with a respective one of a plurality of paths.

Example C10d. The method of Example C10b, further comprising receiving, from the second network node, a plurality of response messages, each response message being associated with a respective one of the plurality of search windows.

Example C10e. The method of any one of Examples C10a to C10d, wherein the plurality of measurement request messages are transmitted sequentially according to a time interval.

Example C11. The method of any one of Examples C1 to C10e, wherein the search window information comprises a search window information element (IE) (i.e., AoA search window information).

Examples C12. The method of any one of Examples C1 to C11, wherein the message comprises configuration information for performance of at least one measurement by the second network node.

Example C13. The method of Example C12, wherein the configuration information comprises a Sounding Reference Signal (SRS) configuration.

Example C14. The method of any one of Examples C12 to C13, wherein at least one measurement comprises at least one of: an Uplink Relative Time of Arrival (UL-RTOA) measurement, an Uplink Round-Trip-Time (UL RTT) measurement, an Enhanced Cell-ID (e-CID) measurement, an AoA measurement, and an ZoA measurement.

Example C15. The method of any one of Examples C1 to C14, further comprising autonomously determining by the first network node to include the search window information in the message.

Example C16. The method of Example C15, wherein autonomously determining to include the search window information in the message is based on receiving information from the second network node that the second network node used previously provided search window information.

Example C17. The method of any one of Examples C1 to C14, further comprising: receiving a request for the search window information from the second network node, and wherein the search window information is included in the message based on the request for the search window information.

Example C18. The method of Example C17, wherein the request for the search window information is received in a message from the second network node during an initial exchange of configuration information between the first network node and second network node.

Example C19. The method of Example C17, wherein the configuration information comprises a Sounding Reference Signal (SRS) configuration.

Example C20. The method of any one of Examples C1 to C19, wherein the measurements are received in a response message.

Example C21. The method of Example C20, wherein the response message comprises at least one of: PCI, CGI, and/or TRP ID of at least one measurement; an UL AoA; an Uplink Sounding Reference Signal-Reference Signal Received Power (UL SRS-RSRP); a time stamp associated with at least one measurement; and a quality level associated with at least one measurement.

Example C22a. The method of any one of Examples C20 to C21, wherein the response message comprises a NRPPA measurement response message.

Example C22b. The method of any one of Examples C20 to C21, wherein the response message comprises a F1AP Positioning Measurement response message and the first network node comprises a gNodeB with a split architecture.

Example C23. The method of any one of Examples C20 to C22b, wherein the response message comprises feedback associated with how and/or whether the search window information was used by the second network node.

Example C24. The method of Example C23, wherein the feedback is indicated as a Boolean flag.

Example C25. The method of any one of Examples C23 to C24, wherein the feedback indicates that a usable reference signal was received based on the search window information.

Example C26. The method of any one of Examples C23 to C24, wherein the feedback indicates that a usable reference signal was not found based on the search window information.

Example C27. The method of any one of Examples C23 to C26, wherein the feedback indicates an actual search window used by the second network node, the actual search window represented as a pair {μ, σ} where μ is an actual angle and σ the uncertainty level of the expected angle.

Example C28. The method of Example C27, wherein each of μ, σ can be integers ranging from 0 to N-1 so that their resolution is 360/N degrees.

Example C29. The method of any one of Examples C23 to C28, wherein the feedback indicates an actual search window used by the second network node, the actual search window represented as a pair {k₁, k₂} where k₁ is a lower bound of the actual search window and k₂ is an upper bound of the actual search window.

Example C30. The method of Example C29, wherein each of {k₁, k₂} can be integers ranging from 0 to N-1 so that their resolution is 360/N degrees.

Example C31. The method of any one of Examples C23 to C30, wherein the feedback comprises a list of actual sub-windows.

Example C32a. The method of any one of Examples C20 to C31, wherein the response message comprises indicates that the second network node used a search window that is different from the search window information.

Example C32b. The method of any one of Examples C20 to C32a, wherein the response message indicates whether the second network node is configured to only report measurements generated using the search window information from the first network node and/or whether the second network node is configured to report measurements generated using the search window information and measurements generated outside the search window information.

Example C33. The method of any one of Examples C to C32, wherein the at least one measurement comprises: at least one measurement generated using the search window information from the first network node, and/or at least one measurement generated using the search window that is different from the search window information.

Example C34. The method of any one of Examples C1 to C32, wherein the at least one measurement comprises only measurements generated using the search window information from the first network node.

Example C35. The method of any one of Examples C1 to C34, further comprising transmitting the refined and/or adapted search window information to the second network node.

Example C36. The method of any one of Examples C1 to C35, wherein the first network node comprises a Location Management Function.

Example C37. The method of any one of Examples C1 to C36, wherein the second network node comprises a gNodeB (gNB) or a Transmission and Reception Point (TRP).

Example C38. A first network node comprising processing circuitry configured to perform any of the methods of Examples C1 to C37.

Example C39. A computer program comprising instructions which when executed on a computer perform any of the methods of Examples C1 to C39.

Example C40. A computer program product comprising computer program, the computer program comprising instructions which when executed on a computer perform any of the methods of Examples C1 to C39.

Example C41. A non-transitory computer readable medium storing instructions which when executed by a computer perform any of the methods of Examples C1 to C39.

Example D1. A method by a first network node comprising: receiving, from a second network node, a message comprising search window information, the search window information comprising: information associated with an expected angle, and information associated with an uncertainty level of the expected angle; and transmitting, to the second network node, at least one measurement based at least partially on the search window information.

Example D2a. The method of Example Embodiment D1, wherein the angle information associated with the expected angle comprises at least one of: an expected Azimuth of Arrival (AoA) and an expected Zenith of Arrival (ZoA).

Example D2b. The method of any one of Examples D1 to D2a, wherein the message comprises a NRPPa Measurement Request message.

Example D2c. The method of any one of Examples D1 to D2a, wherein the message comprises a F1 Positioning Measurement Request message and wherein the network node comprises a gNodeB with a split architecture.

Example D2d. The method of any one of Examples D1 to D2c, wherein the at least one measurement comprises a plurality of measurements that are transmitted continuously.

Example D2e. The method of any one of Examples D1 to D2c, wherein the at least one measurement comprises a plurality of measurements that are transmitted substantially continuously.

Example D2f. The method of any one of Examples D1 to D2c, wherein the at least one measurement comprises a plurality of measurements that are transmitted periodically.

Example D2h. The method of any one of Examples D1 to D2f, further comprising receiving refined search window information based on the at least one measurement.

Example D2i, The method of Example Embodiment D2h, wherein the refined search window information is refined to maximize a probability that a line of sight associated with a wireless device is within a search window.

Example D2j. The method of any one of Examples D2h to D2i, wherein the search window information is refined for each TRP in an area.

Example D2k. The method of any one of Examples D2h to D2j, wherein the search window information is refined based on at least one location of a TRP.

Example D21. The method of any one of Examples D1 to D2k, wherein the first network node is configured to report only measurements that are generated within a search window associated with the search window information.

Example D2m. The method of any one of Examples D1 to D2k, wherein the first network node is configured to report measurements that are generated within a search window associated with the search window information and measurements that are generated outside the search window associated with the search window information.

Example D2n. The method of any one of Examples D1 to D2o, further comprising transmitting, to the second network node, information indicating that the first network node is configured to report only measurements that are generated within a search window associated with the search window information.

Example D2o. The method of any one of Examples D1 to D2o, further comprising transmitting, to the second network node, information indicating that the first network node is configured to report measurements that are generated within a search window associated with the search window information and measurements that are generated outside the search window associated with the search window information.

Example D3. The method of any one of Examples D1 to D2o, wherein the information associated with the uncertainty level of the expected angle indicates a value representing a level of uncertainty of the expected angle.

Example D4. The method of any one of Examples D1 to D2o, wherein the information associated with the uncertainty level of the expected angle indicates that the first network node has no knowledge of the a level of uncertainty of the expected angle.

Example D5. The method of any one of Examples D1 to D4, wherein the search window information comprises a pair {μ, σ} where μ is the expected angle and σ the uncertainty level of the expected angle.

Example D6. The method of Example D5, wherein each of μ, σ can be integers ranging from 0 to N-1 so that their resolution is 360/N degrees.

Example D7. The method of any one of Examples D1 to D6, wherein the search window information comprises a pair {k₁, k₂} where k₁ is a lower bound of a window and k₂ is an upper bound of the window.

Example D8. The method of Example D7, wherein each of {k₁, k₂} can be integers ranging from 0 to N-1 so that their resolution is 360/N degrees.

Example D9. The method of any one of Examples D1 to D8, wherein the search window information comprises a list of sub-windows.

Example D10a. The method of any one of Examples D1 to D9, wherein the message comprises a measurement request message.

Example D10b. The method of Example D10a, further comprising receiving a plurality of measurement request messages, each measurement request message comprising a respective one of a plurality of search windows.

Example D10c. The method of Example D10b, wherein each of the plurality of search windows is associated with a respective one of a plurality of paths.

Example D10d. The method of Example D10b, further comprising receiving, from the second network node, a plurality of response messages, each response message being associated with a respective one of the plurality of search windows.

Example D10e. The method of any one of Examples D10b to D10d, wherein the plurality of measurement request messages are transmitted sequentially according to a time interval.

Example D11. The method of any one of Examples D1 to D10e, wherein the search window information comprises a search window information element (IE) (i.e., AoA search window information).

Example D12. The method of any one of Examples D1 to D11, wherein the message comprises configuration information for performance of at least one measurement by the first network node.

Example D13. The method of Example D12, wherein the configuration information comprises a Sounding Reference Signal (SRS) configuration.

Example D14. The method of any one of Examples D12 to D13, further comprising performing the at least one measurement based on at least one of: the configuration information and the search window information.

Example D15. The method of any one of Examples D12 to D14, wherein at least one measurement comprises at least one of: an Uplink Relative Time of Arrival (UL-RTOA) measurement, an Uplink Round-Trip-Time (UL RTT) measurement, an Enhanced Cell-ID (e-CID) measurement, an AoA measurement, and an ZoA measurement.

Example D16. The method of any one of Examples D12 to D15, further comprising transmitting a response message to the second network node.

Example D17. The method of Example D16, wherein the response message comprises at least one of: PCI, CGI, and/or TRP ID of at least one measurement; an UL AoA; an Uplink Sounding Reference Signal-Reference Signal Received Power (UL SRS-RSRP); a time stamp associated with at least one measurement; and a quality level associated with at least one measurement.

Example D18a. The method of any one of Examples D16 to D17, wherein the response message comprises a NRPPA measurement response message.

Example D18b. The method of any one of Examples D16 to D17, wherein the response message comprises a F1AP Positioning Measurement response message and the first network node comprises a gNodeB with a split architecture.

Example D19. The method of any one of Examples D16 to D18b, wherein the response message comprises feedback associated with how and/or whether the search window information was used by the first network node.

Example D20. The method of Example D19, wherein the feedback is indicated as a Boolean flag.

Example D21. The method of any one of Examples D19 to D20, wherein the feedback indicates that a usable reference signal was received by the first network node based on the search window information.

Example D22. The method of any one of Examples D19 to D20, wherein the feedback indicates that a usable reference signal was not found by the first network node based on the search window information.

Example D23. The method of any one of Examples D19 to D22, wherein the feedback indicates an actual search window used by the first network node, the actual search window represented as a pair {μ, σ} where μ is an actual angle and σ the uncertainty level of the expected angle.

Example D24. The method of Example D23, wherein each of μ, σ can be integers ranging from 0 to N-1 so that their resolution is 360/N degrees.

Example D25. The method of any one of Examples D19 to D24, wherein the feedback indicates an actual search window used by the first network node, the actual search window represented as a pair {k₁, k₂} where k₁ is a lower bound of the actual search window and k₂ is an upper bound of the actual search window.

Example D26. The method of Example D25, wherein each of {k₁, k₂} can be integers ranging from 0 to N-1 so that their resolution is 360/N degrees.

Example D27. The method of any one of Examples D19 to D26, wherein the feedback comprises a list of actual sub-windows.

Example D28a. The method of any one of Examples D16 to D27, wherein the response message comprises indicates that the first network node used a search window that is different from the search window information.

Example D28b. The method of any one of Examples D16 to D28a, wherein the response message indicates whether the first network node is configured to only report measurements generated using the search window information from the first network node and/or whether the first network node is configured to report measurements generated using the search window information and measurements generated outside the search window information.

Example D29a. The method of any one of Examples D16 to D28b, wherein the response message comprises: at least one measurement generated using the search window information from the second network node, and/or at least one measurement generated using the search window that is different from the search window information.

Example D29b. The method of any one of Examples D1 to D29a, wherein the at least one measurement comprises only measurements generated using the search window information from the second network node.

Example D30. The method of any one of Examples D20 to D29b, further comprising receiving, from the second network node, refined and/or adapted search window information based on the response message.

Example D31. The method of any one of Examples D1 to D30, further comprising: transmitting a request for the search window information to the second network node, and wherein the search window information is included in the message based on the request for the search window information.

Example D32. The method of Example D31, wherein the request for the search window information is transmitted in a message to the second network node during an initial exchange of configuration information between the first network node and second network node.

Example D33. The method of Example D32, wherein the configuration information comprises a Sounding Reference Signal (SRS) configuration.

Example D34. The method of any one of Examples D1 to D33, wherein the first network node comprises a gNodeB (gNB) or a Transmission and Reception Point (TRP).

Example D35. The method of any one of Examples D1 to D34, wherein the second network node comprises a Location Management Function (LMF).

Example D36. A first network node comprising processing circuitry configured to perform any of the methods of Examples D1 to D35.

Example D37. A computer program comprising instructions which when executed on a computer perform any of the methods of Examples D1 to D35.

Example D38. A computer program product comprising computer program, the computer program comprising instructions which when executed on a computer perform any of the methods of Examples D1 to D35.

Example D39. A non-transitory computer readable medium storing instructions which when executed by a computer perform any of the methods of Examples D1 to D35.

Example E1. A network node comprising: processing circuitry configured to perform any of the steps of any of the Group A, B, C, and D Examples; power supply circuitry configured to supply power to the wireless device.

Example E2. A communication system including a host computer comprising: processing circuitry configured to provide user data; and a communication interface configured to forward the user data to a cellular network for transmission to a wireless device, wherein the cellular network comprises a network node having a radio interface and processing circuitry, the network node's processing circuitry configured to perform any of the steps of any of the Group A, Group B, Group C, and Group D Examples.

Example E3. The communication system of the previous embodiment further including the network node.

Example E4. The communication system of the previous 2 embodiments, further including the wireless device, wherein the wireless device is configured to communicate with the network node.

Example E5. The communication system of the previous 3 embodiments, wherein: the processing circuitry of the host computer is configured to execute a host application, thereby providing the user data; and the wireless device comprises processing circuitry configured to execute a client application associated with the host application.

Example E6. A method implemented in a communication system including a host computer, a network node and a wireless device, the method comprising: at the host computer, providing user data; and at the host computer, initiating a transmission carrying the user data to the wireless device via a cellular network comprising the network node, wherein the network node performs any of the steps of any of the Group A, Group B, Group C, and Group D Examples.

Example E7. The method of the previous embodiment, further comprising, at the network node, transmitting the user data.

Example E8. The method of the previous 2 embodiments, wherein the user data is provided at the host computer by executing a host application, the method further comprising, at the wireless device, executing a client application associated with the host application.

Example E9. A wireless device configured to communicate with a network node, the wireless device comprising a radio interface and processing circuitry configured to performs the of the previous 3 embodiments.

Example E10. A communication system including a host computer comprising a communication interface configured to receive user data originating from a transmission from a wireless device to a network node, wherein the network node comprises a radio interface and processing circuitry, the network node's processing circuitry configured to perform any of the steps of any of the Group A, Group B, Group C, and Group D Examples.

Example E11. The communication system of the previous embodiment further including the network node.

Example E12. The communication system of the previous 2 embodiments, further including the wireless device, wherein the wireless device is configured to communicate with the network node.

Example E13. The communication system of the previous 3 embodiments, wherein: the processing circuitry of the host computer is configured to execute a host application; the wireless device is configured to execute a client application associated with the host application, thereby providing the user data to be received by the host computer.

Example E14. The method of any of the previous embodiments, wherein the network node comprises a base station.

Example E15. The method of any of the previous embodiments, wherein the wireless device comprises a user equipment (UE).

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1.-33. (canceled)

34. A method performed by a first network node comprising:
transmitting, to a second network node, a message comprising search window information, the search window information comprising:
information associated with an expected angle wherein the expected angle comprises at least one of:
an expected Azimuth of Arrival, AoA, and
an expected Zenith of Arrival, ZoA, and
information associated with an uncertainty level of the expected angle, and receiving, a response message from the second network node, wherein the response message comprises at least one of:
a Physical Cell Identifier of at least one measurement,
a Cell Global Identifier of at least one measurement,
a Transmission and Reception Point Identifier of at least one measurement;
an uplink AoA;
an Uplink Sounding Reference Signal-Reference Signal Received Power;
a time stamp associated with at least one measurement; and
a quality level associated with at least one measurement.

35. The method of claim 34, further comprising:
receiving, based at least partially on the search window information, at least one measurement from the second network node; and
refining and/or adapting the search window information based on the at least one measurement.

36. The method of claim 34, wherein:
the message comprises a New Radio Positioning Protocol A, NRPPA, measurement request message,
the response message comprises NRPPA measurement response message,
the first network node comprises a location server, and
the second network node comprises a Central Unit, CU.

37. The method of claim 34, wherein:
the message comprises a F1 Positioning Measurement Request message, and
the first network node comprises a Central Unit, CU, and the second network node comprises a Distributed Unit, DU.

38. The method of claim 34, wherein the information associated with the uncertainty level of the expected angle indicates:
a value representing a level of uncertainty of the expected angle, or that the first network node has no knowledge of the level of uncertainty of the expected angle.

39. The method of claim 34, wherein the message comprises Sounding Reference Signal, SRS, configuration information for performance of at least one measurement by the second network node, and wherein at least one measurement comprises at least one of: an Uplink Relative Time of Arrival, UL-RTOA, measurement, an Uplink Round-Trip-Time, UL RTT, measurement, an Enhanced Cell-ID, e-CID, measurement, an AoA measurement, and an ZoA measurement.

40. The method of claim 34, further comprising: receiving a request for the search window information from the second network node, and wherein the search window information is included in the message based on the request for the search window information.

41. The method of claim 34, wherein the response message indicates that the second network node used a search window that is different from the search window information.

42. A method performed by a second network node comprising:
receiving, from a first network node, a message comprising search window information, the search window information comprising:
information associated with an expected angle, wherein the expected angle comprises at least one of:
an expected Azimuth of Arrival, AoA, and
an expected Zenith of Arrival, ZoA, and
information associated with an uncertainty level of the expected angle, and
transmitting a response message to the first network node,
wherein the response message comprises at least one of:
a Physical Cell Identifier of at least one measurement,
a Cell Global Identifier of at least one measurement,
a Transmission and Reception Point Identifier of at least one measurement;
an uplink AoA;
an Uplink Sounding Reference Signal-Reference Signal Received Power;
a time stamp associated with at least one measurement; and
a quality level associated with at least one measurement.

43. The method of claim 42, further comprising:
transmitting, based at least partially on the search window information, at least one measurement to the first network node; and
receiving, from the first network node, additional search window information that is adapted based on the at least one measurement.

44. The method of claim 42, wherein:
the message comprises a New Radio Positioning Protocol A, NRPPA, measurement request message,
the response message comprises NRPPA measurement response message,
the first network node comprises a location server, and
the second network node comprises a Central Unit, CU.

45. The method of claim 42, wherein:
the message comprises a F1 Positioning Measurement Request message,
the first network node comprises a Central Unit, CU, and
the second network node comprises a Distributed Unit, DU.

46. The method of claim 42, wherein the information associated with the uncertainty level of the expected angle indicates:
a value representing a level of uncertainty of the expected angle, or that the second network node has no knowledge of the level of uncertainty of the expected angle.

47. The method of claim 42, wherein the message comprises Sounding Reference Signal, SRS, configuration information for performance of at least one measurement by the second network node.

48. The method of claim 47, further comprising performing the at least one measurement based on at least one of: the configuration information and the search window information.

49. The method of claim 47, wherein at least one measurement comprises at least one of: an Uplink Relative Time of Arrival, UL-RTOA, measurement, an Uplink Round-Trip-Time, UL RTT, measurement, an Enhanced Cell-ID, e-CID measurement, an AoA measurement, and an ZoA measurement.

50. The method of claim 42, wherein the response message comprises indicates that the second network node used a search window that is different from the search window information.

51. The method of claim 42, further comprising: transmitting a request for the search window information to the first network node, and wherein the search window information is included in the message based on the request for the search window information.

52. A first network node adapted to:
transmit, to a second network node, a message comprising search window information, the search window information comprising:
information associated with an expected angle, wherein the expected angle comprises at least one of:
an expected Azimuth of Arrival, AoA, and
an expected Zenith of Arrival, ZoA, and
information associated with an uncertainty level of the expected angle; and
receive a response message from the second network node,
wherein the response message comprises at least one of:
a Physical Cell Identifier of at least one measurement,
a Cell Global Identifier of at least one measurement,
a Transmission and Reception Point Identifier of at least one measurement;
an uplink AoA;
an Uplink Sounding Reference Signal-Reference Signal Received Power;
a time stamp associated with at least one measurement; and
a quality level associated with at least one measurement.

53. A second network node adapted to:
receive, from a first network node, a message comprising search window information, the search window information comprising:
information associated with an expected angle, wherein the expected angle comprises at least one of:
an expected Azimuth of Arrival, AoA, and
an expected Zenith of Arrival, ZoA, and
information associated with an uncertainty level of the expected angle, and
transmit a response message to the first network node,
wherein the response message comprises at least one of:
a Physical Cell Identifier of at least one measurement,
a Cell Global Identifier of at least one measurement,
a Transmission and Reception Point Identifier of at least one measurement;
an uplink AoA;
an Uplink Sounding Reference Signal-Reference Signal Received Power;
a time stamp associated with at least one measurement; and
a quality level associated with at least one measurement.
